(19) United States
(12) Patent Application Publication
(10) Pub. No.: US 2024/0396256 A1
(43) Pub. Date: Nov. 28, 2024

(54) SINGLE-PAIR ETHERNET MOUNT HOUSING

(71) Applicant: CommScope Technologies LLC, Hickory, NC (US)

(72) Inventor: Paul John PEPE, Clemmons, NC (US)

(73) Assignee: CommScope Technologies LLC, Hickory, NC (US)

(21) Appl. No.: 18/694,214

(22) PCT Filed: Sep. 19, 2022
(86) PCT No.: PCT/US2022/076654

§ 371 Date: Mar. 21, 2024

Related U.S. Application Data
(60) Provisional application No. 63/246,397, filed on Sep. 21, 2021.

(51) Int. Cl. H01R 13/506; H01R 13/52; H01R 13/6582; H01R 24/64; H01R 31/06

(52) U.S. Cl. CPC H01R 13/506; H01R 13/5213; H01R 13/6582; H01R 24/64; H01R 31/06; H01R 2201/04

(57) ABSTRACT

A single pair Ethernet mount housing receives either a single pair Ethernet coupler or connector jack and is positioned within a mount opening of, for example, a faceplate or panel module. An interior interface feature removably retains the coupler or connector jack within a channel of the housing. An exterior interface feature removably retains the mount housing within the mount opening of the faceplate or panel module. The mount housing can be configured in an unshielded configuration (e.g., a plastic body) or a shielded configuration (e.g., a plastic body and a metal spring beam). The shielded configuration utilizes the metal spring beam to establish a bonding path between a shielded coupler or shielded connector jack and a shielded face plate or shielded panel module.

### CROSS-REFERENCE TO RELATED APPLICATION(S)

This application is being filed on Sep. 19, 2022 as a PCT International Patent Application and claims the benefit of U.S. Patent Application Ser. No. 63/246,397, filed on Sep. 21, 2021, the disclosure of which is incorporated herein by reference in its entirety.

### TECHNICAL FIELD

The present disclosure is directed to single-pair ethernet systems for transmitting data, power or both data and power over a single twisted pair of wire conductors and, more specifically, to a mount housing for a single pair connector jack or coupler.

### BACKGROUND

A single twisted pair of conductors can be used to transmit data and/or power over a communications network that includes, for example, computers, servers, cameras, televisions, and other electronic devices including those on the internet of things (IoT), etc. In the past, this has been performed through use of Ethernet cables and connectors that typically include four pairs of conductors that are used to transmit four differential signals. Differential signaling techniques, where each signal is transmitted over a balanced pair of conductors, are used because differential signals may be affected less by external noise sources and internal noises sources such as crosstalk as compared to signals that are transmitted over unbalanced conductors.

In Ethernet cables, the insulated conductors of each differential pair are tightly twisted about each other to form four twisted pairs of conductors, and these four twisted pairs may be further twisted about each other in a so-called “core twist.” A separator may be provided that is used to separate (and hence reduce coupling between) at least one of the twisted pairs from at least one other of the twisted pairs. The four twisted pairs and any separator may be enclosed in a protective jacket. Ethernet cables are connectorized with Ethernet connectors; a single Ethernet connector is configured to accommodate all four twisted pairs of conductors. However, it is possible that data and/or power transfer can be effectively supported through a singled twisted pair of conductors with its own more compact connector and cable. A mount housing that can support a single pair Ethernet connector jack or coupler within, for example, a faceplate or panel module, can be an important element in broadening the use of data and/or power transfer over a single pair of electrical conductors.

### SUMMARY

The present disclosure is directed to single pair Ethernet mount housing. The single pair Ethernet mount housing receives either a single pair Ethernet coupler or connector jack and is positioned within a mount opening of, for example, a faceplate or panel module. An interior interface feature removably retains the coupler or connector jack within a channel of the housing. An exterior interface feature removably retains the mount housing within the mount opening of the faceplate or panel module. The mount housing can be configured in an unshielded configuration (e.g., a plastic body) or a shielded configuration (e.g., a plastic body and a metal spring beam). The shielded configuration utilizes the metal spring beam to establish a bonding path between a shielded coupler or shielded connector jack and a shielded face plate or shielded panel module.

In certain aspects, the present disclosure is directed to a mount housing. The mount housing has a body having an exterior surface and an open-ended channel extending therethrough. The exterior surface of the mount housing has an exterior interface feature that interfaces with a mount opening framework to retain the body of the mount housing within a mount opening. The channel of the mount housing includes an interior interface feature that retains a single pair Ethernet coupler or single pair Ethernet connector jack within.

In certain aspects, the present disclosure is directed to method of mounting a single Pair Ethernet coupler or connector jack in a faceplate. The method includes: (a) inserting the single pair Ethernet coupler or connector jack into a mount housing, the mount housing including an interior interface feature to removably retain the single pair Ethernet coupler or connector jack within a channel of the mount housing; and (b) inserting the mount housing, which may or may not already be supporting the coupler or connector jack, into a mount opening having a framework thereabout, the mount housing including an exterior interface feature that interfaces with the framework to removably retain the mount housing within the mount opening.

In certain aspects, the present disclosure is directed to a single pair Ethernet communication system for transmitting both data and power. The system includes a coupler or connector jack, a mount housing and a faceplate or panel module. The coupler couples a first single pair Ethernet free connector with a second single pair Ethernet free connector while a connector jack couples a single pair Ethernet free connector to a single pair Ethernet cable. The mount housing includes an exterior surface and an open-ended channel that receives and removably retains the coupler or connector jack therein. The faceplate or panel module includes a mount opening and a framework about the mount opening. The mount opening of the faceplate or panel module receives the mount housing while the framework interfaces with an exterior interface feature of the mount housing.

In certain aspects, a telecommunications adapter mount can include a main body defining an internal cavity for receiving a telecommunications connector; a first connection arrangement located on an exterior portion of the main body and being configured to removably secure the main body within an opening, the first connection feature being one or more of a flexible latch, a ramped boss, a projection, and a flex tab; and a second connection arrangement located within the internal cavity and being configured to removably secure the telecommunications connector within the channel.

In some examples, the telecommunications connector is a single pair Ethernet coupler or connector jack.

In some examples, a forward face of the single pair Ethernet coupler or connector jack extends beyond a forward face of the main body.

In some examples, the second connection arrangement comprises a flex latch extending into the channel from an upper surface of the channel.

In some examples, the first connection arrangement provides at least one of an SL-Series interface configuration, a Keystone interface configuration, and an M-Series interface configuration.

In some examples, the main body is formed from a plastic material.

In some examples, a metal spring beam is provided and configured to interface with the telecommunications connector, which is in a shielded configuration, and to interface with a framework defining the opening, which is in a shielded configuration, to establish a bonding path between the telecommunications connector and the framework upon insertion of the telecommunications connector into the channel and upon insertion of the main body in the opening.

In some examples, a dust shield is mounted to a forward face of the main body.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE FIGURES

FIGS. 1A-1B illustrate example embodiments of cables having single twisted pairs of conductors.

FIGS. 2A-2D illustrate an example embodiment of a free connector for a single pair of electrical conductors including an assembled view, an exploded assembly view, a cross section of a forward connector body of the connector, and a pair of electrical contacts of the connector, respectively.

FIGS. 3A-3C illustrate an example embodiment of a fixed connector, which is configured to mate with the free connector of FIGS. 2A-2D, including an assembled perspective view, a front view, and a pair of electrical contacts of the fixed connector, respectively.

FIGS. 4A-4B illustrate an example embodiment of a shielded coupler including an assembled perspective view and an exploded assembly perspective view of the coupler, respectively.

FIGS. SA-SC provide a front perspective, a side perspective, and a rear perspective view, respectively, of a first housing of the coupler of FIGS. 4A-4B.

FIGS. 6A-6D provide a side perspective, a front perspective, a rear perspective, and a cross-sectional view, respectively, of a second housing of the coupler of FIGS. 4A-4B.

FIGS. 7A-7B provide a side perspective view and a front perspective view of a metal shield of the coupler of FIGS. 4A-4B.

FIG. 8 is a perspective view of a pair of contacts of the coupler of FIGS. 4A-4B.

FIGS. 9A-9B provide perspective views of the first and second housings coupled.

FIGS. 10A-10B provide cross-sectional views of the assembled coupler of FIG. 4A.

FIGS. 11A-11B provide perspective views of the coupler of FIGS. 4A-4B and

two of the free connectors of FIGS. 2A-2D.

FIGS. 12A-12B illustrate an example configuration of a high density panel maintaining a plurality of couplers with each coupler capable of electrically coupling two free connectors.

FIGS. 13A-13D illustrate an embodiment of a shielded coupler including a shadowed side perspective, a side perspective, a front/rear perspective (without contacts), and a front/rear perspective of the coupler (with contacts), respectively.

FIGS. 14A-14C illustrate an embodiment of a bonding shield contact of the coupler of FIGS. 13A-13D including a top perspective, a bottom perspective, and a side view, respectively, of the bonding shield contact.

FIGS. 15A-15C provide perspective views of an embodiment of a contact sub-assembly of the coupler of FIGS. 13A-13D.

FIGS. 16A-16B are cross-sectional views of the coupler of FIGS. 13A-13D taken along lines 16A-16A and 16B-16B of FIG. 17, respectively.

FIG. 17 is a perspective view of the coupler of FIGS. 13A-13D receiving first and second free connectors of FIGS. 2A-2D.

FIGS. 18A-18B provide a perspective view and an exploded view, respectively, of a three-way coupler.

FIGS. 19A-19B provide a perspective view and an exploded view, respectively, of a four-way coupler.

FIGS. 20A-20B provide a top view and an exploded view, respectively, of a multi-way coupler.

FIG. 21 is an exploded view of a single pair Ethernet connector jack.

FIGS. 22A-22B are forward and rearward perspective views, respectively, of a housing of the connector jack of FIG. 21.

FIGS. 23A-23B are forward and rearward perspective views, respectively, of a forward housing assembly of the connector jack of FIG. 21.

FIGS. 24A-24D are a forward perspective view, a rearward perspective view, a forward view, and a rearward view, respectively, of a rear housing assembly of the connector jack of FIG. 21.

FIGS. 25A-25B are forward and rearward perspective views, respectively, of an alternative embodiments of a forward assembly housing for a connector jack.

FIGS. 26A-26D are a forward perspective view, a rearward perspective view, an exploded rear perspective view, and a cross-sectional view, respectively, of a mount housing and faceplate.

FIGS. 27A-27C are a first forward perspective view, a second forward perspective view, and a rear perspective view, respectively, of a mount housing.

FIGS. 28A-28C are a rear perspective view, a forward perspective view, and a side perspective view, respectively, of a mount housing with a spring beam.

FIGS. 29A-29D are a rear perspective view of a mount housing and faceplate, a cross-sectional view the mount housing and faceplate, a perspective view of the mount housing, and a side view of the mount housing, respectively.

FIGS. 30A-30B are a rear perspective view and a forward perspective view, respectively, of a mount housing.

FIGS. 31A-31B are a cross-sectional view and a rear perspective view, respectively, of a mount housing with a spring beam.

FIGS. 32A-32B are a cross-sectional view and a rear perspective view, respectively, of a mount housing with a spring beam.

FIGS. 33A-33G are a perspective view of a mount housing with a dust cover, a side view of the mount housing with the dust cover, a perspective view of the mount housing without the dust cover, a rearward and forward perspective view of a first dust cover, and a rearward and forward perspective of a second dust cover, respectively.

FIGS. 34A-34C are a forward perspective view, a rearward perspective view, and a cross-sectional view, respectively, of a mount housing and faceplate.

FIGS. 35A-35B are a rearward perspective view and a forward perspective view, respectively, of a mount housing.

FIGS. 36A-36B are a rearward perspective view and a cross-sectional view, respectively, of a mount housing with a spring beam.

### DETAILED DESCRIPTION

The present disclosure is directed to single pair Ethernet mount housing. The single pair Ethernet mount housing receives either a single pair Ethernet coupler or connector jack and is positioned within a mount opening of, for example, a faceplate or panel module. An interior interface feature removably retains the coupler or connector jack within a channel of the housing. An exterior interface feature removably retains the mount housing within the mount opening of the faceplate or panel module. The mount housing can be configured in an unshielded configuration (e.g., a plastic body) or a shielded configuration (e.g., a plastic body and a metal spring beam). The shielded configuration utilizes the metal spring beam to establish a bonding path between a shielded coupler or shielded connector jack and a shielded face plate or shielded panel module.

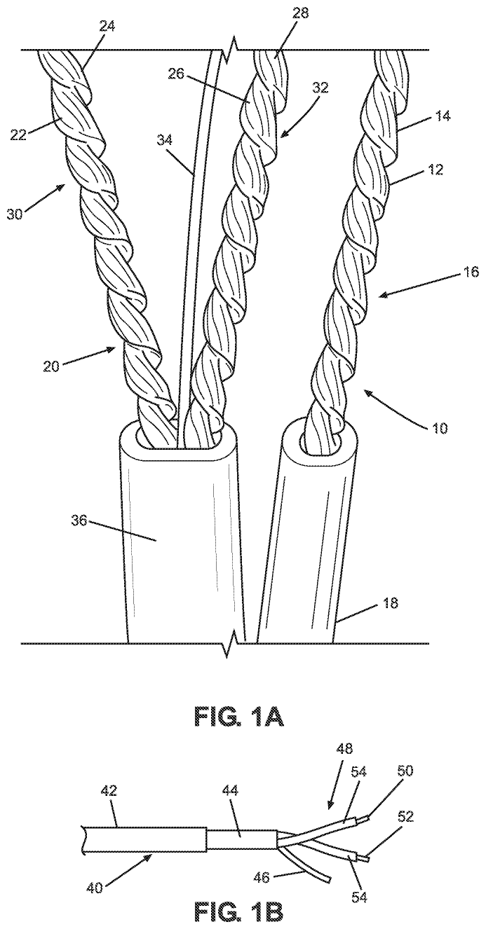

FIG. 1A illustrates two example embodiments of cables containing one or more single twisted pairs of conductors. A first cable 10 includes first and second conductors 12, 14 that are twisted together to form a single twisted pair 16. The conductors 12, 14 are enclosed by a protective jacket 18. A second cable 20 includes first through fourth conductors 22, 24, 26, 28. Conductors 22 and 24 are twisted together to form a first single twisted pair 30, and conductors 26 and 28 are twisted together to form a second single twisted pair 32. The twisted pairs 30 and 32 are separated by a separator 34, and are encased in a protective jacket 36. In certain example embodiments, the cables 10, 20 include a number of twisted pairs greater than two. In certain example embodiments, each single twisted pair of conductors, e.g., 16, 30, 32, is configured for data transmission up to 600 MHZ (ffs) and has a current carrying capacity up to 1 A. Each single twisted pair of conductors, e.g., 16, 30, 32, can be connectorized with the various embodiments or combination of embodiments of free connectors and fixed connectors as described herein. FIG. 1B is an example of a shielded cable 40. The shielded cable 40 includes an outer jacket 42, a foil shield 44, a drain wire 46, and a single twisted pair 48 of conductors 50 and 52; each of the conductors 50 and 52 is provided with insulation 54.

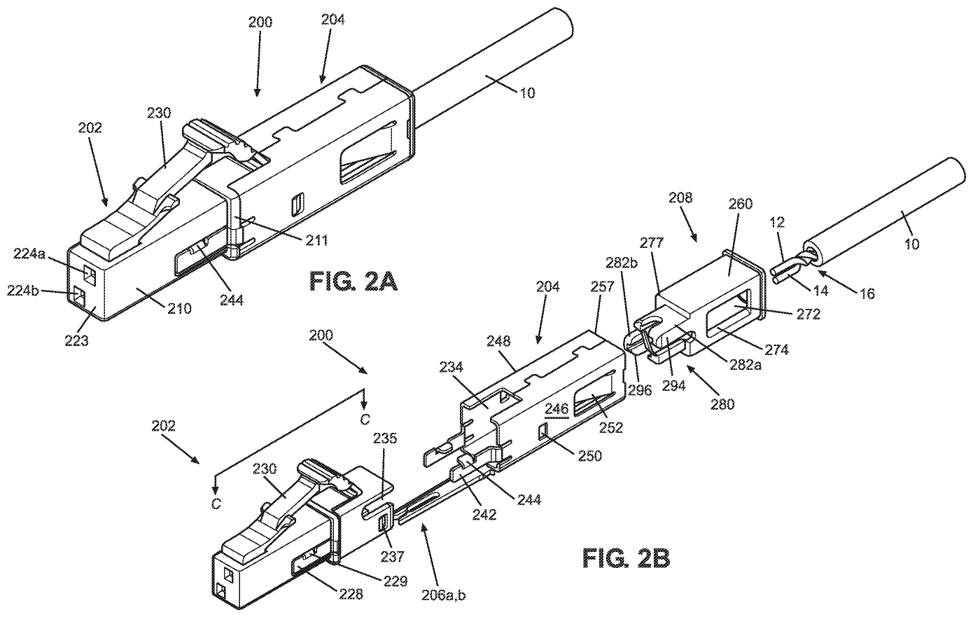

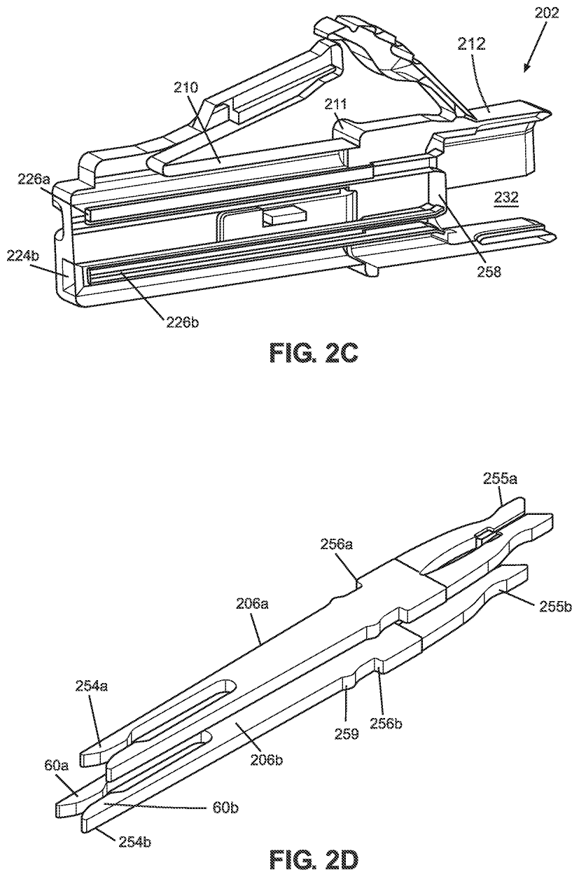

Referring to FIGS. 2A-2D, an example embodiment of a free connector 200 for a single twisted pair of electrical conductors is illustrated. Free connector 200 includes a forward connector body 202, a metal frame 204, a pair of electrical contacts 206a, 206b, and a rear connector body 208. Free connector 200 can be coupled to a single twisted pair of conductors, e.g., conductors 12 and 14 of the single twisted pair 16 of cable 10.

The forward connector body 202 includes an elongate forward portion 210 and a rear receiving portion 212 that is separated by a shoulder 211.

The elongate forward portion 210 of the forward connector body 202 includes a forward face 223 having a pair of offset openings 224a, 224b corresponding to contact receiving channels 226a, 226b; the openings 224a, 224b receiving pin contacts that electrically interface with the electrical contacts 206a, 206b. In certain embodiments, a recess 228 is provided on each side face of the elongate forward portion 210 to interface with and retain the metal frame 204. Each recess 228 includes a recessed notch 229 to receive an interfacing tab 244 of the metal frame 204 to further ensure that the metal frame 204 remains secured to the forward connector body 202. The forward connector body 202 also includes a cantilevered latch 230.

The rear receiving portion 212 of the forward connector body 202 is unitary (e.g., molded as a single unit) with the elongate forward portion 210 of the forward connector body 202. The rear receiving portion 212 defines a central cavity 232 that provides rear access to the contact receiving channels 226a, 226b of the elongate forward portion 210. Each side face 231, 233 of the rear receiving portion 212 includes a slot 235 to interface with the rear connector body 208 and an outward extending tab 237 to interface with the metal frame 204.

The metal frame 204 of the free connector 200 comprises a metal shell body 240 having a central cavity 234 that is slidable over the rear receiving portion 212 of the forward connector body 202. The metal frame 204 is held in place about the rear receiving portion 212 through use of a pair of flex tabs 242 that interface with corresponding recesses 228 of the forward connector body 202. Each of the flex tabs 242 includes an inward facing tab 244 to interface with recessed notch 229 of the forward connector body 202. Each side face 246, 248 of the metal frame 204 includes an opening 250 to interface with outward extending tab 237 of the forward connector body 202. Each point of interface between the metal frame 204 and the forward connector body 202 assists in securing the metal frame 204 to the forward connector body 202. Each side face 246, 248 of the metal frame 204 is additionally equipped with an inward directed beam 252 (e.g., shield beam) to establish an electrical interface with a cable shield (foil or drain wire) of the cable carrying the single pair of conductors (e.g., see FIG. 1B). Note that, while the metal frame 204 includes a shield beam for interfacing with a shield of a shielded cable, the metal frame 204 can also be utilized in conjunction with a non-shielded cable. In the instance of a non-shielded cable, the metal frame provides additional structural support to the connector 200. In certain non-shielded uses, the frame 204 is alternatively made of a non-metal material, e.g., plastic.

Electrical contacts 206a, 206b each include a forward portion having a tuning fork receptacle contact 254a, 254b, while a rear portion of each of the electrical contacts 206a, 206b includes an insulation displacement contact (IDC) 255a, 255b. Each tuning fork receptacle contact 254a, 254b includes a pair of opposing spring arms 60a, 60b presenting an angled opening to receive a pin contact. Each of the electrical contacts 206a, 206b includes a shoulder 256a, 256b that interfaces with a stop 258 (see FIG. 2C) within the elongate forward portion 210 of the forward connector body 202. The electrical contacts 206a, 206b include one or more tangs 259 to help retain each of the tuning fork receptacle contacts 254a, 254b within their respective contact receiving channels 226a, 226b of the forward connector body 202.

The rear connector body 208 of the free connector 200 includes a rear body portion 260 that defines a central cavity 272 into which is inserted a pair of conductors (e.g., conductors 12, 14). Each side face is provided with an elongate opening 274 into which the inward directed beams 252 of the metal frame 204 extend wherein an electrical interface with the foil (or drain wire) of a conductor within the cavity 272 is established. A latch (not shown) on a lower face of the rear body portion 260 interfaces with a cut-out (not shown) of the metal frame 204 to secure the rear connector body 208 to the metal frame 204. A lip edge 277 of the rear body portion 260 seats against a rear face 257 of the metal frame 204.

The rear connector body 208 of the free connector 200 includes a contact receiving portion 280 that extends forward from the rear body portion 260. The contact receiving portion 280 is essentially divided into a first half 282a to accommodate the upper positioned electrical contact 206a and a second half 282b to accommodate the lower positioned electrical contact 206b. The first half 282a of the contact receiving portion 280 includes an upward channel that is contoured to direct the end of a conductor upward (e.g., a 90 degree bend) to extend through a contact receiving slot. The second half 282b of the contact receiving portion 280 includes a downward channel that is contoured to direct the end of a conductor downward (e.g., a 90 degree bend) to extend through a contact receiving slot.

The IDC contacts 255a, 255a of the electrical contact 206a,206b are inserted into their respective contact receiving slots to establish an electrical interface with the conductor extending therethrough. The IDC contacts 255a, 255b apply a normal force to the respective conductor and cuts through both the insulation of the conductor and a portion of the conductor itself to create the electrical interface. Note that the electrical interface is established without requiring crimping of the conductor to the electrical contact, i.e., the electrical interface is crimp-less. The upward channel is, in part, defined by an upper outward extending arm 294 while the downward channel is, in part, defined by a lower outward extending arm 296. Each of upper outward extending arm 294 and lower outward extending arm 296 interface with respective corresponding slots 235 of the forward connector body 202 when the free connector 200 is assembled to assist in aligning and stabilizing the rear connector body 208 relative to the forward connector body 202.

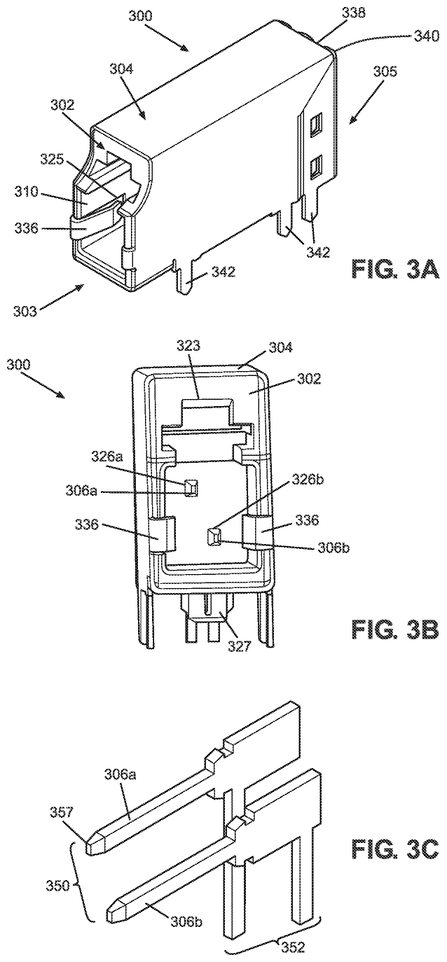

An example of a fixed connector 300, suitable to mate with free connector 200, is illustrated in FIGS. 3A-3C. The fixed connector 300 generally includes a housing body 302, a metal frame 304, and a pair of pin contacts 306a, 306b (straight or bent for board mounting). A forward end 303 and a rearward end 305 further define the fixed connector 300.

The housing body 302 of the fixed connector 300 includes a forward central channel 310 that receives the free connector 200. A notch 323 is provided within the housing body 302 to interface with the cantilevered latch 230 of the free connector 200. Further, side recesses 325 in each side face serve as an interface element for the metal frame 304. A mounting pin 327 extends from the housing body 302 and through the metal frame 304 for circuit board mounting of the connector 300. The housing body further includes openings 326a, 326b to channels (not shown) into which the pin contacts 306a, 306b are inserted; when fully inserted, the pin contacts 306a, 306b extend into the forward central channel 310.

The metal frame 304 of the fixed connector 300 is a metal shell defining a central cavity that is slidable over the housing body 302. The metal frame 304 is held in place about the housing body 302 through use of a pair of clips 336 that interface with the side recesses 325. In certain embodiments, a back face 338 of the metal frame is enclosed with a back panel 340, while in other embodiments, the back face 338 is left open. Further, in certain embodiments, the metal frame 304 is provided with one or more shield pins 342 that are insertable into vias in an application where the fixed connector 300 is board mounted.

Each of the pin contacts 306a, 306b of the fixed connector 300 include a forward portion 350 and a rear portion 352 that can be electrically coupled to a conductor, e.g. conductor 12, in any suitable manner. The forward portion 350 includes tapered faces that form a four-sided pyramid shape with a flattened apex 357; the flattened apex 357 having a rectangular or square cross-section.

Further details regarding free connectors, fixed connectors, and couplers can be found in PCT publications WO 2018/200528, WO 2019/165466, WO 2020/190758; and WO2021/067274. The identified PCT publications are hereby incorporated by reference.

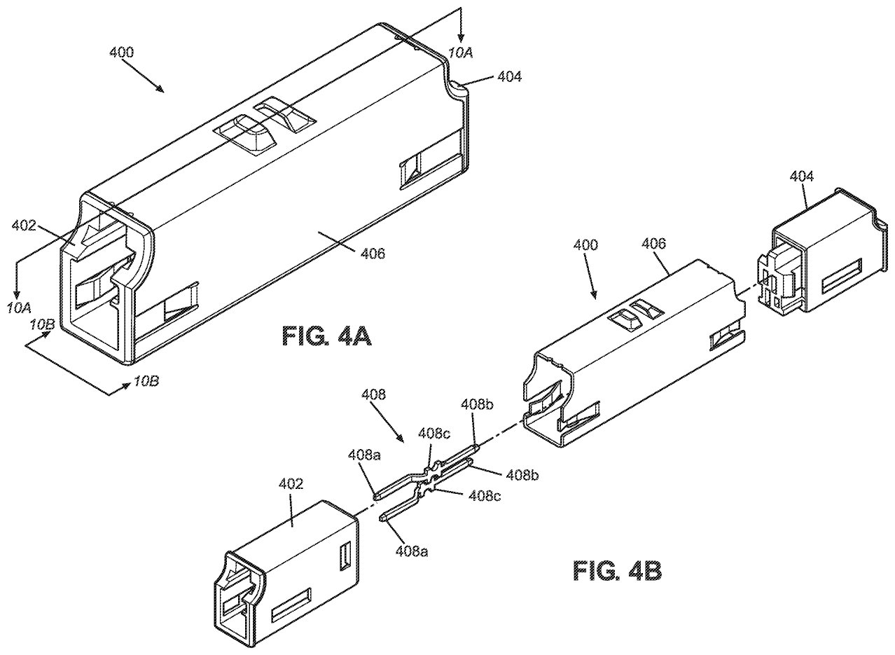

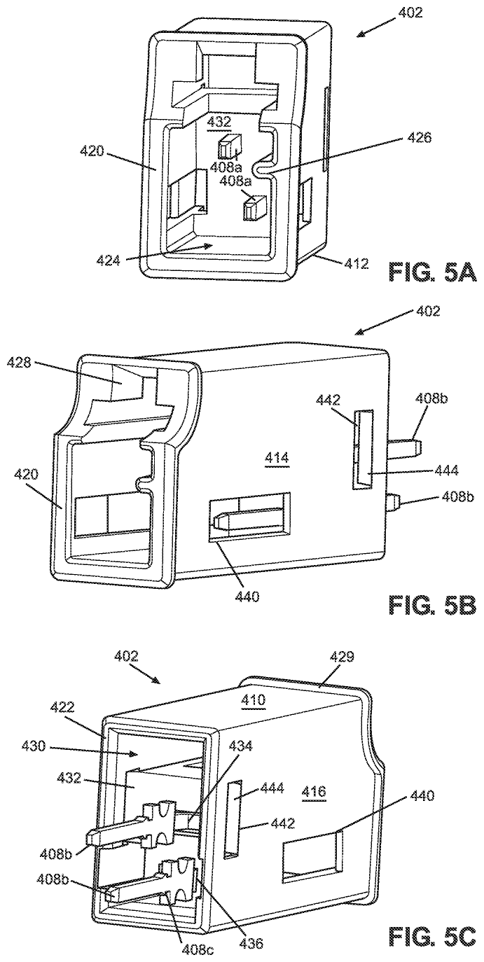

Referring to FIGS. 4A-4B, an example embodiment of a coupler 400 is illustrated. As shown, the coupler 400 includes a first housing 402, a second housing 404, a metal shield 406, and a pair of contacts 408, each having a forward contact 408a and a rearward contact 408b separated by a central portion 408c.

FIGS. 5A-5C further illustrate the details of the first housing 402 with the contacts 408 inserted therein. As shown, the first housing 402 includes an upper face 410 and a lower face 412 connected by a first side face 414 and a second side face 416 that, together, define a forward face 420 and a rearward face 422. The forward face 420 surrounds a forward cavity 424 into which extends the forward contact 408a of each of the pair of contacts 408. In certain embodiments, a projection 426 projects from one, or more, of the faces 414, 416, 420, 422 into the forward cavity 424 to align a connector 200 for insertion and/or prevent a non-compatible connector from being inserted therein. The forward face 420 further defines a recessed notched 428 that is configured to interface with and retain the cantilevered latch 230 of the connector 200. A lip edge 429 extends around the forward face 420 and serves to abut a first end 722 of the metal shield 406 when the first housing 402 is received within the first end 722.

The rearward face 422 of the first housing 402 defines a rearward cavity 430 that is separated from the forward cavity 422 by a wall 432. The wall 432 is provided with first and second channels 434, 436 that receive the forward contacts 408a of each of the pair of contacts 408 allowing them to pass through to the forward cavity 422. The wall 432 further acts as a stop for the central portion 408c of each of the contacts 408 to prevent over-insertion of the forward contacts 408a.

Each of the side faces 414, 416 includes a first elongate opening 440 that receives a flex tab 726 of the metal shield 406 that retains the first housing 402 within the metal shield 406; the flex tab 726 extends into the forward cavity 422 to make contact with the metal frame 204 of a connector 200 that is received therein. Each of the side faces 414, 416 includes a second elongate opening 442, which is generally oriented perpendicular to the first elongate opening 440, and includes a flanged edge 444 that extends into the rearward cavity 430. The flanged edge 444 of the first housing 402 interfaces with a hooked tab 636 of the second housing 404 to maintain a mechanically coupled position with the second housing 404.

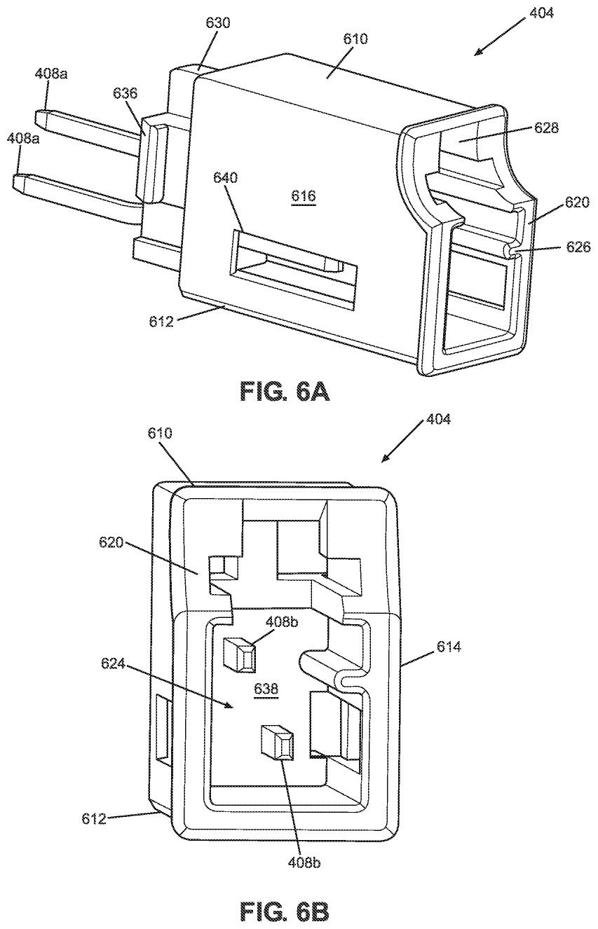

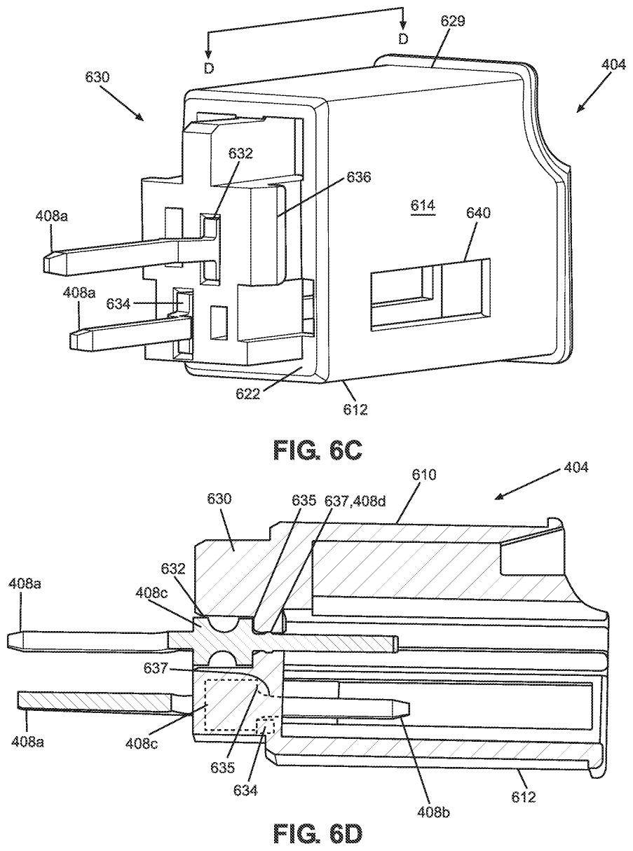

FIGS. 6A-6D further illustrate the details of the second housing 404 with the contacts 408 inserted therein. As shown, the second housing 404 includes an upper face 610 and a lower face 612 connected by a first side face 614 and a second side face 616 that, together, define a forward face 620 and a rearward face 622. The forward face 620 surrounds a forward cavity 624 into which extends the rearward contact 408b of each of the pair of contacts 408. In certain embodiments, a projection 626 projects from one, or more, of the faces 614, 616, 620, 622 into the forward cavity 624 to align a connector 200 for insertion and/or prevent a non-compatible connector from being inserted therein. The forward face 620 further defines a recessed notched 628 that is configured to interface with and retain the cantilevered latch 230 of the connector 200. A lip edge 629 surrounds the forward face 620 and serves to abut a second end 724 of the metal housing 406 when inserted within the metal shield 406.

The rearward face 622 of the second housing 404 frames a rear projection 630 that is sized to be received within the rear cavity 430 of the first housing 402. The rear projection 630 includes first and second channels 632, 634 that receives the rearward contacts 408b of the pair of contacts 408 allowing them to pass through to the forward cavity 624. The channels 632, 634 on the rear projection 630 include openings that are sized to receive the central portion 408c of each of the pair of contacts 408. A stop 635 is formed within each of the channels 632, 634 to prevent over-insertion of the rearward contact 408b of the pair of contact 408.

Further, each of channels 632, 634 is formed to include a retention notch 637 that interfaces with a tang 408d on each of the pair of contacts 408. The interface of the retention notch 637 and tang 408d ensures a correctly-oriented and fixed position for each of the contacts 408. Each side of the rear projection 630 includes a hooked tab 636 that interfaces with the flanged edge 444 of the first housing to mechanically couple the first housing 402 to the second housing. A rear wall 638 separates the forward cavity 624 from the rear projection 630.

Each of the side walls 614, 616 of the second housing includes an elongate opening 640 that receives a flex tab 728 of the metal shield 406 that retains the second housing 404 within the metal shield 406; the flex tab 728 extends into the forward cavity 624 to make contact with the metal frame 204 of a connector 200 that is received therein.

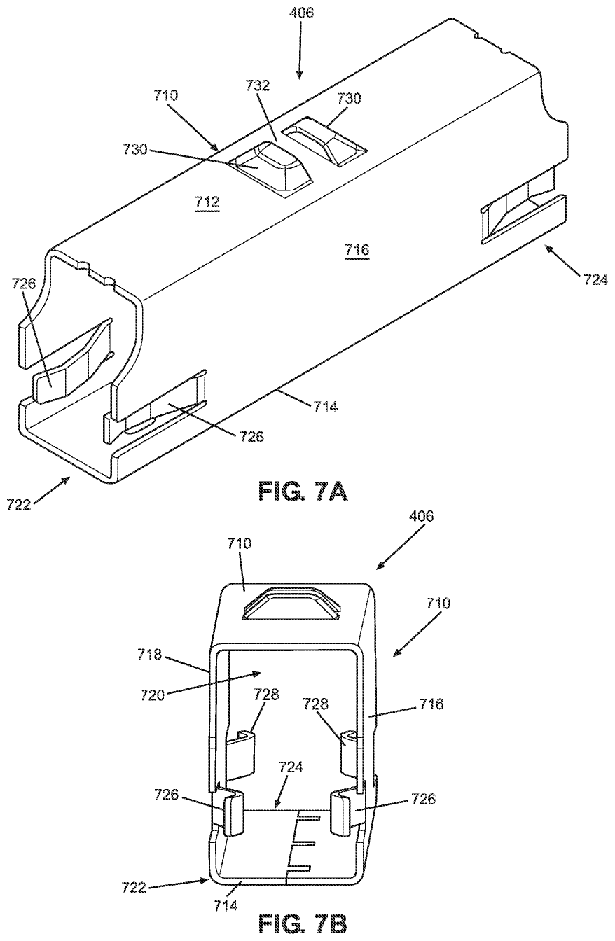

FIGS. 7A-7B further illustrate the details of the metal shield 406. As shown, the metal shield 406 generally comprises a singular housing 710 having an upper face 712 and a lower face 714 connected by side faces 716,718 that define a central channel 720 extending therethrough. The housing 710 includes a first end 722 that receives the first housing 402 and a second end 724 that receives the second housing 404. Each of the side walls 716, 718 at the first end 722 of the housing 710 includes a pair of opposed flex tabs 726 that are received within the first elongate opening 440 of each of the side faces 414, 416 of the first housing 402. Each of the side walls 716,718 at the second end 724 of the housing 710 includes another pair of opposed flex tabs 728 that are received within the elongate opening 640 of each of the side walls 614, 616 of the second housing 404. The pairs of flex tabs 726, 728 flex outward to receive the respective housing 402, 404 and flex inward to retain each of the housings 402, 404 therein. The inward flexing of the flex tabs 726, 728 additionally provides contact between the flex tabs 726, 728 and the metal tabs 242 of the metal frame 204 of the connector 200 that is received within each of the first housing 402 and the second housing 404.

The upper face 712 of the metal shield 406 presents a pair of opposing bosses 730 that extend away from the upper face 712. The pair of opposing bosses 730 define a central open channel 732. The bosses 730 and the open channel 732 present an interface that is used to secure the position of the coupler 400 in a high density panel. In certain embodiments, the metal shield 406 is manufactured through use of a sheet metal stamping process wherein the resulting stamped component is subsequently formed into the illustrated metal shield 406. It should be noted that, in certain non-shielding applications, metal shield 406 can, alternatively, be fabricated from non-metal materials.

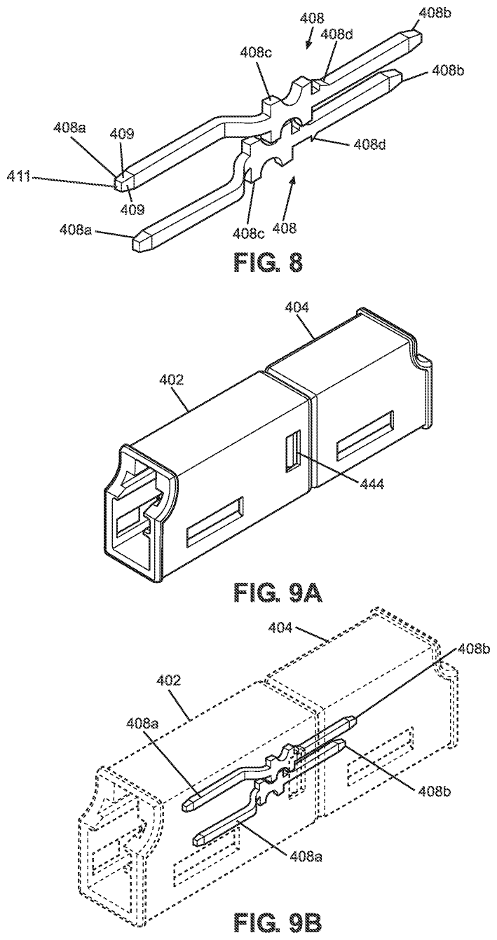

FIG. 8 provides a closer perspective view of the pair of contacts 408. Each of the contacts 408 includes a forward contact 408a and rearward contact 408b separated by a central portion 408c. A tang 408d is provided on each of the contacts 408 to secure positioning of the contact 408 within the second housing 404. Each of the forward and rearward contacts 408a, 408b are pin contacts having a square or rectangular cross-section wherein the end of the pin includes four tapered faces 409 that form a four-sided pyramid shape with a flattened apex 411. In certain embodiments, the pins are of a rounded configuration. Notably the contacts 408 are offset from one another to help prevent alien crosstalk between couplers 400 and connectors 200 in high density application. Further, the forward contacts 408a are configured in a cross-over configuration to maintain polarity between the two connectors 200 when electrically coupled with the contacts 408.

Manufacturing the coupler 400 includes inserting the first housing 402 into the first end 722 of the metal shield 406. The rearward contacts 408b of the pair of contacts 408 are inserted into the first and second channels 632, 634 (see FIG. 6C) of the second housing 404 until secured in position by tangs 408d. The second housing 404, with forward contacts 408a extending therefrom, is inserted into the second end 724 of the metal shield 406 and further inserted into the rear cavity of the first housing 402. The forward contacts 408a are received within the first and second channels of 434, 436 (see FIG. 5C) of the first housing 402 until pushed therethrough and the hooked tabs 636 (see FIG. 6A) of the second housing 404 pass and then engage the flanged edge 444 (see FIG. 5C) of the first housing 402, thereby mechanically coupling the first housing 402 to the second housing 404. Flex tabs 726 of the metal shield 406 receive and retain the first and second housings 402, 404 within the metal shield 406.

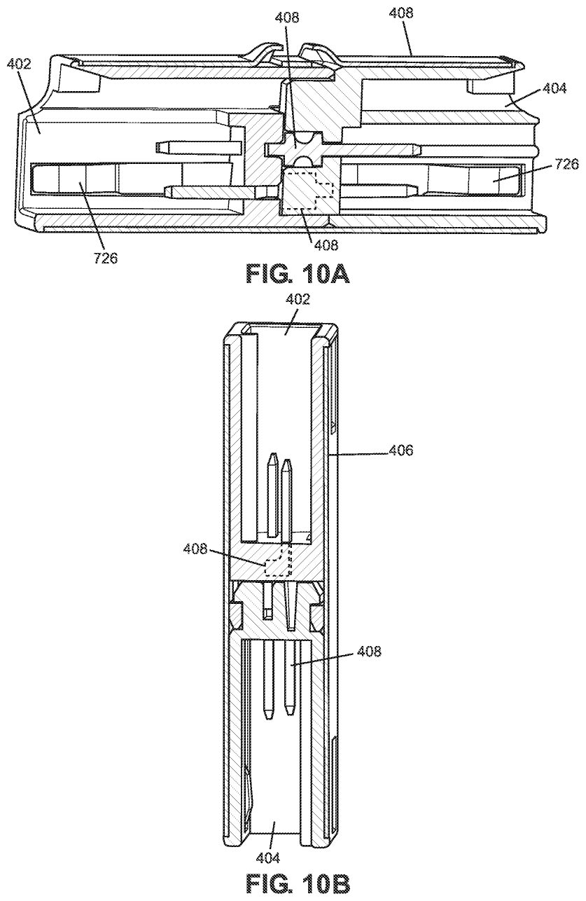

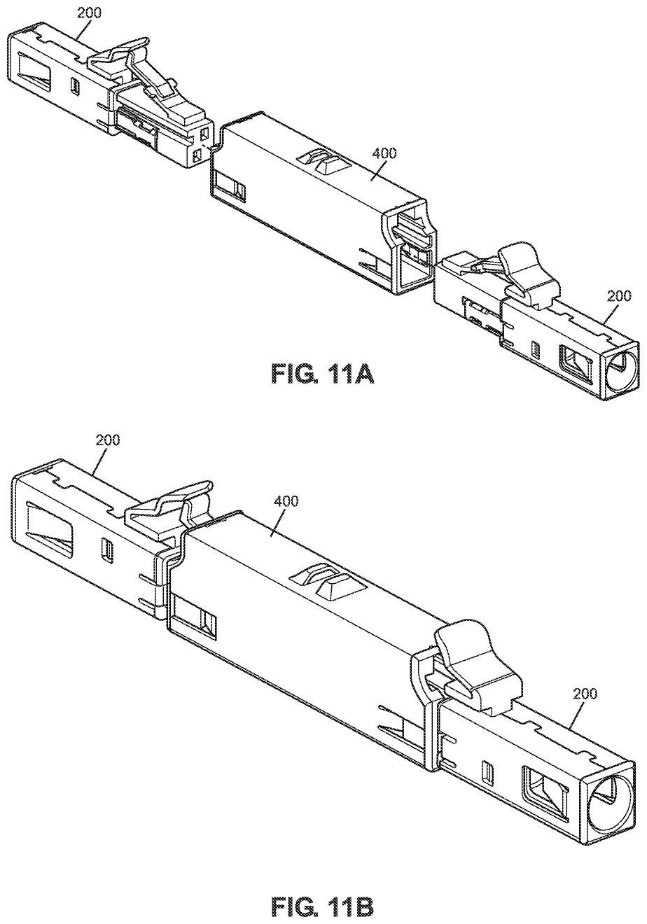

FIGS. 9A and 9B illustrate the first and second housings 402, 404 coupled to one another, absent the metal shield 406, with FIG. 9B illustrating the position of the pair of contacts 408 within the coupled first and second housings 402, 404. FIGS. 10A and 10B provide cross-sectional views of the assembled coupler, including the metal shield 406, taken along lines 10A-10A and 10B-10B, respectively, of FIG. 4A, with each illustrating the placement of the first housing 402, the second housing 404, the metal shield 406, and the pair of contacts 408. FIGS. 11A and 11B illustrate the assembled coupler 400 with two of the free connectors 200 ready to be received by the coupler 400 and with the two connectors 200 removably received within the coupler 400 and electrically coupled, respectively.

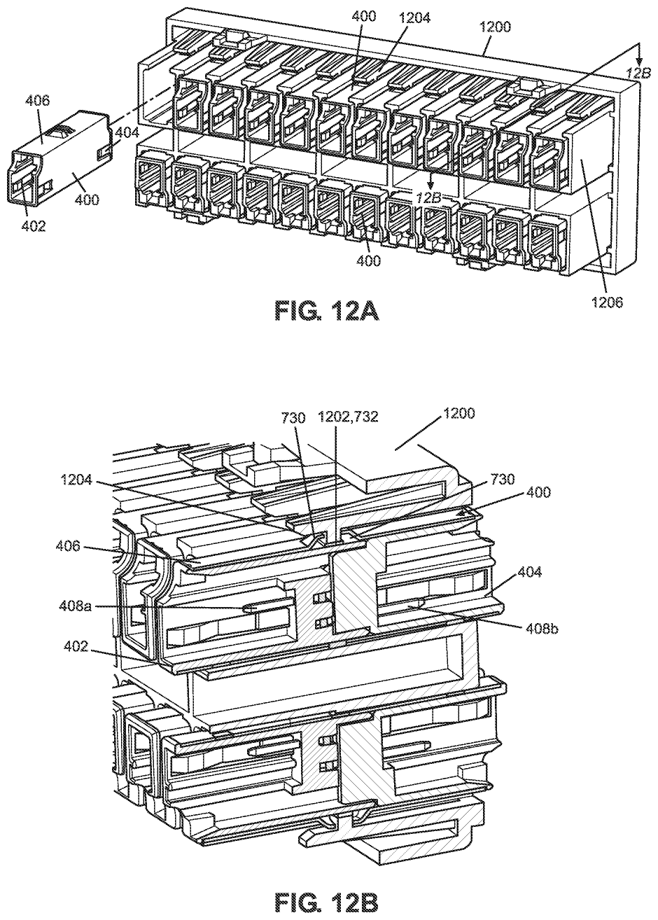

FIGS. 12A-12B illustrate an example embodiment of a high density panel 1200, which can be shielded or non-shielded, that supports a plurality of couplers 400. Each of the couplers 400 serves to electrically couple two free connectors 200. FIG. 12B illustrates the interface between the bosses 730/channel 732 of the metal shield 406 and a retaining element 1202 of a flex arm 1204 of the high density panel 1200 that retains the coupler 400 in a desired position within a coupler slot 1206.

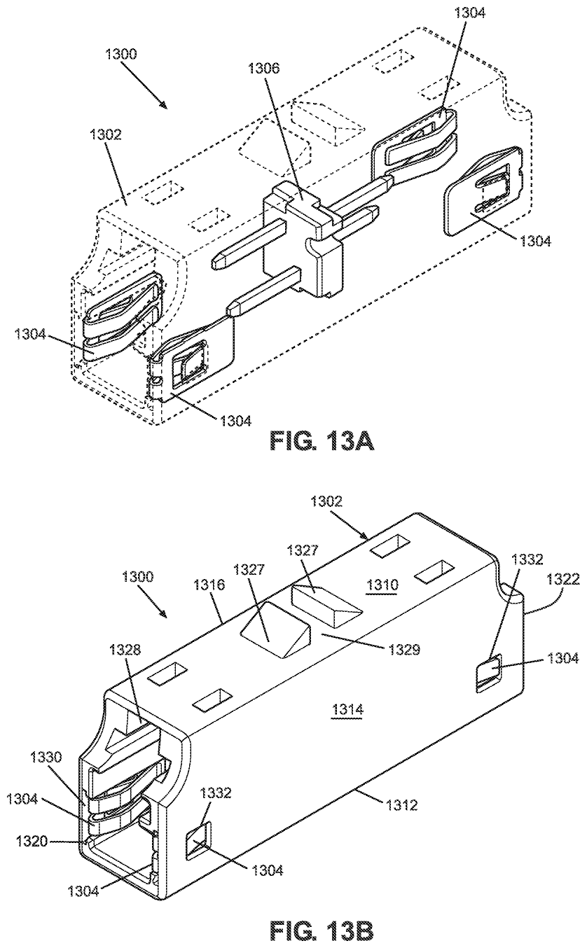

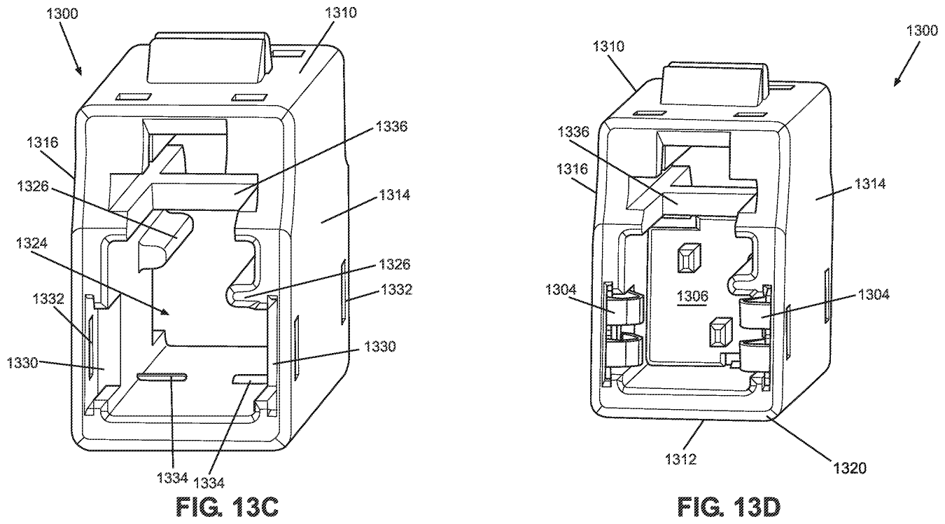

FIGS. 13A-13D illustrate another example embodiment of a shielded coupler 1300. The coupler 1300 includes a singular metal housing 1302, four bonding shield contacts 1304, and a contact sub-assembly 1306.

The housing 1302, which is typically die cast, includes an upper face 1310 and a lower face 1312 connected by a first side face 1314 and a second side face 1316 that, together, define identical first and second end faces 1320, 1322. The first and second end faces 1320, 1322 surround a central cavity 1324 that extends the length of the coupler 1300. In certain embodiments, a projection 1326 projects from one, or more, of the faces 1314, 1316, 1320, 1322 into the central cavity 1324 to align a connector 200 for insertion and/or prevent a non-compatible connector from being inserted therein. Each of the first and second end faces 1320, 1322 further defines a recessed notch 1328 that is configured to interface with and retain the cantilevered latch 230 of the connector 200. The upper face 1310 of the housing includes first and second bosses 1327 that extend away from the upper face and oppose one another to define a channel 1329 therebetween.

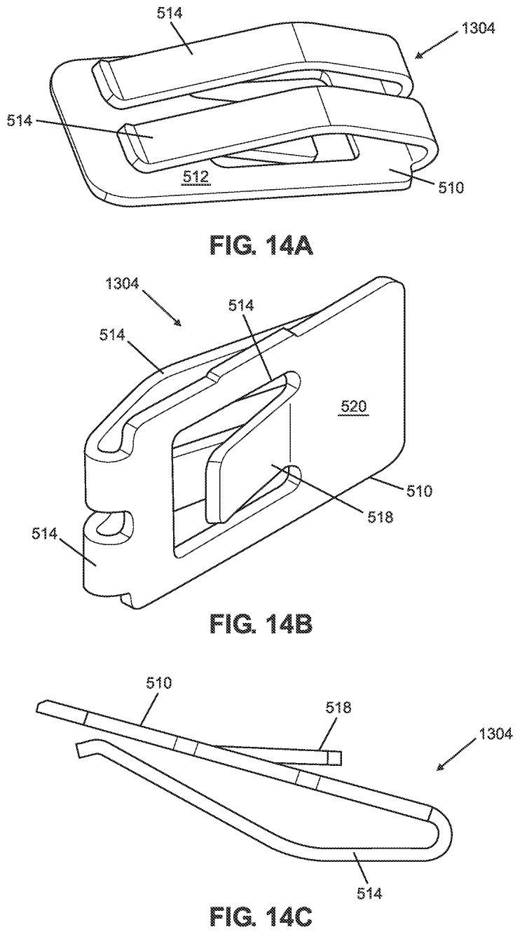

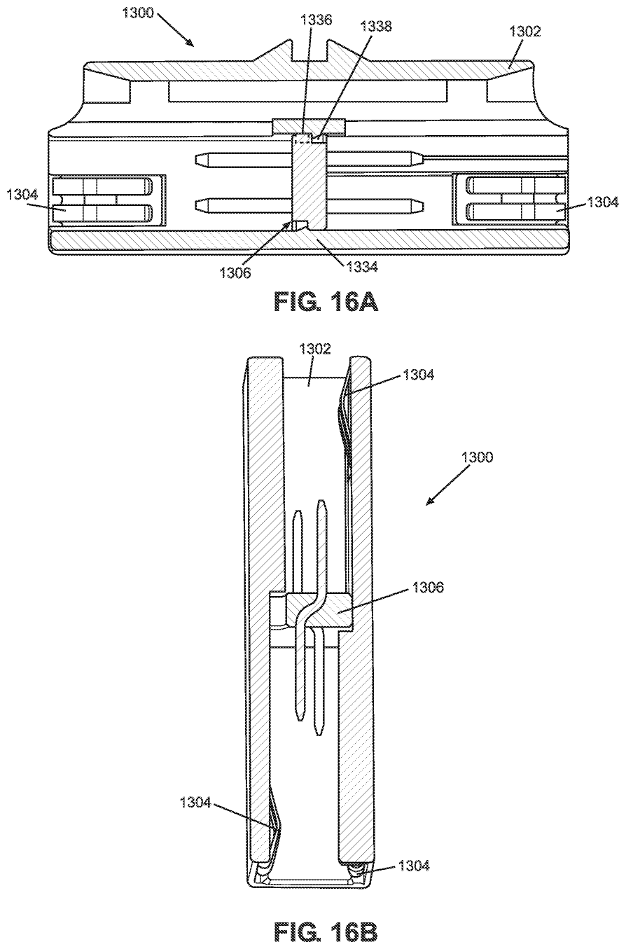

The interior of each of the first and second side faces 1314, 1316 includes two recesses 1330, e.g., a total of four recesses 1330, each of which receives one of the four bonding shield contacts 1304, which are press fit therein. Proximate each of the recesses 1330 is an opening 1332 that extends through the respective side face 1314, 1316. Each of the openings 1332 interfaces with an outward extending prong 1418 (see FIG. 14B) of the bonding shield contact 1304 to assist in maintaining the position of the bonding shield contact 1304 relative to the housing 1302. An interior surface of the lower face 1312 includes first and second ramped projections 1334 (e.g., ramped in opposite directions) that interface with the contact sub-assembly 1306 to assist in maintaining the contact sub-assembly 1306 in a central position within the central cavity 1324. A cross-component 1336 extends between the interior surfaces of the first and second side walls 1314, 1316 and presents corresponding first and second ramped projections 1338 (see FIG. 16A) that are ramped in opposite directions (and are ramped in opposite direction to the projection 1334 immediately below). Projections 1338 also interface with the contact sub-assembly 1306 to assist in maintaining the contact sub-assembly 1306 in a central position within the central cavity 1324.

Further details of the metal bonding shield contacts 1304 can be appreciated with respect to FIGS. 14A-14C. As shown, each of the bonding shield contacts 1304 includes a base plate 510 from which extend a pair of flex arms 514 and fold over an upper surface 512 of the base plate 510. When in position within the housing 1302, one or both of metal flex arms 514 will contact one of the metal flex tabs 242 of the metal frame 202 of the free connector 200 (see FIG. 2B) that is received within the housing 1302. An opening 516 in the base plate 510 accommodates a prong 518 that extends outward and away from a bottom surface 520 of the base plate 510. The prong 518 interfaces with the respective opening 1332 in the side faces 1314, 1316 to assist in maintaining the position of the bonding shield contact 1304.

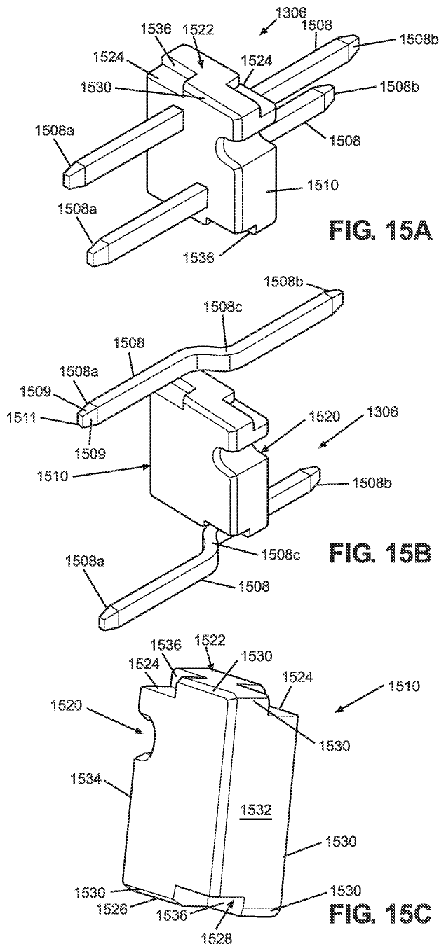

Further details of the contact sub-assembly 1306 can be appreciated with respect to FIGS. 15A-15C. As shown, the sub-assembly 1306 includes a pair of contacts 1508, similar to contacts 408 (see FIG. 8), overmolded with a block 1510. As with contacts 408, each of contacts 1508 includes a forward contact 1508a, a rearward contact 1508b, and a central portion 1508c. Each of the forward and rearward contacts 1508a, 1508b are pin contacts having a square or rectangular cross-section wherein the end of the pin includes four tapered faces 1509 that form a four-sided pyramid shape with a flattened apex 1511. In certain embodiments, the pins are of a rounded configuration. Notably the contacts 1508 are offset from one another to help prevent alien crosstalk between couplers 1300 and connectors 200 in high density applications. Further, the forward contacts 1508a are configured in a cross-over configuration to maintain polarity between the two connectors 200 when electrically coupled with the contacts 1508.

The block 1510 of the contact sub-assembly 1306 includes a side channel 1520 to accommodate the projection 1326 within the central cavity 1324 of the housing 1302. An upper face 1522 of the block 1510 includes recessed first and second corners 1524 that are positioned diagonal to one another. A lower face 1526 of the block 1510 includes first and second recessed corner 1528 that are positioned diagonal to one another and are opposite corners to first and second corners 1524. Edges 1530 surrounding each of the upper face 1522 and lower face 1526, as well as side walls 1532, 1534, of the block 1510 are beveled for easier insertion of the sub-assembly 1306 within the housing 1302 of the coupler 1300. The block 1510, when inserted within the housing 1302, is slid past the ramped projections 1334, 1338 of the housing 1302 into a central position whereby the ramped projections 1334, 338 interface with a wall 1536 that defines each of the recessed corners 1524, 1528.

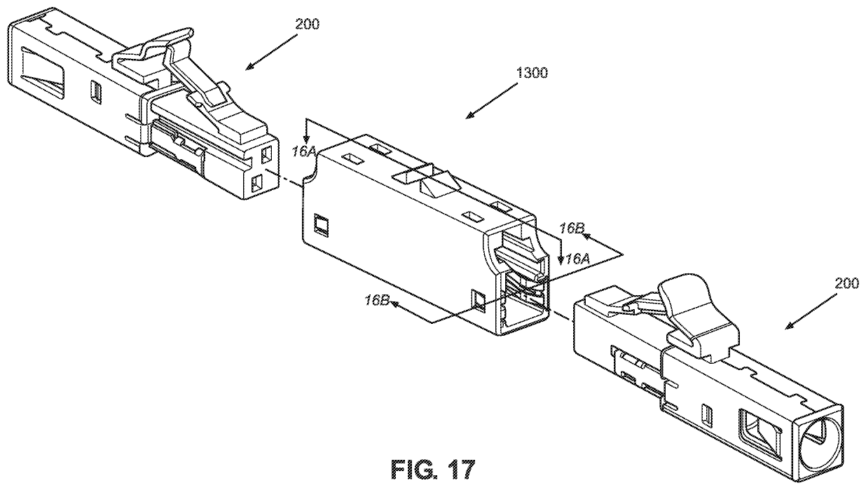

FIGS. 16A-16B provide a side cross-sectional view and top cross-sectional view taken along lines 16A-16A and 16B-16B of FIG. 17, respectively. Each cross-section illustrates the housing 1302, bonding shield contacts 1304, and contact sub-assembly 1306 relative to one another in a fully assembled coupler 1300. FIG. 17 illustrates the coupler 1300 receiving a first free connector 200 and a second free connector 200. As with coupler 400, a plurality of couplers 1300 can be utilized in a high density panel 1200 (see FIGS. 12A-12B).

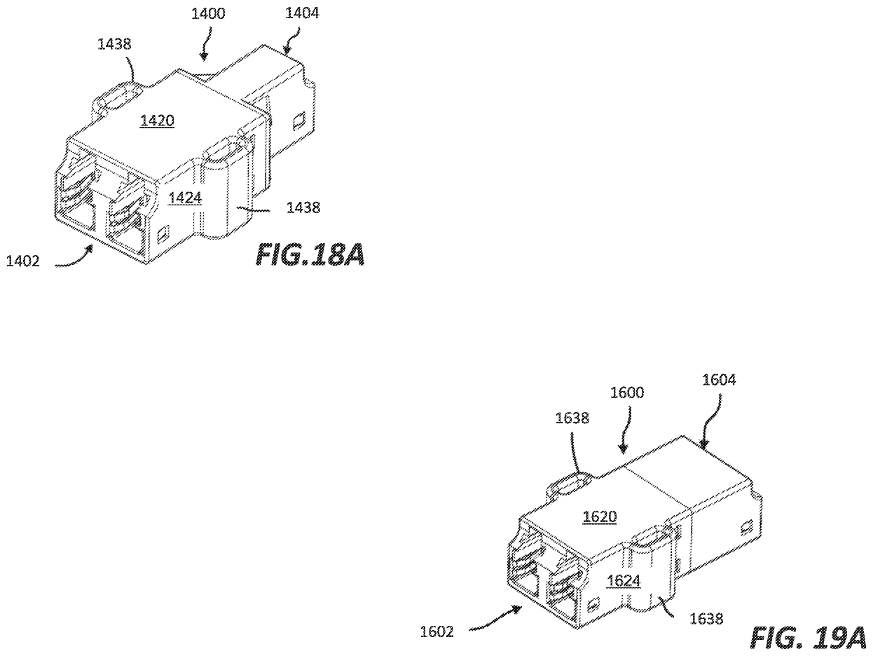

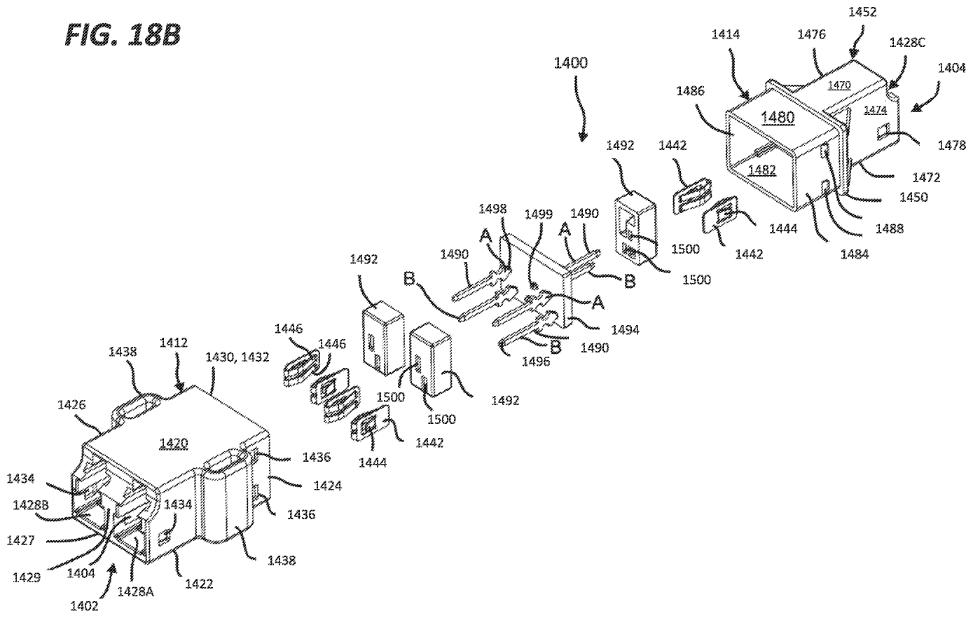

Various multiway couplers for coupling three or four free connectors 200 for the transmission of power, data, or both power and data between the free connectors are illustrated in FIGS. 18A-20B.

Referring to FIGS. 18A-18B, a three-way coupler 1400 includes a housing 1410 comprising a first body portion 1412 presenting the dual-connector end 1402 and a second body portion 1414 presenting the single-connector end 1404. For applications requiring shielding, the housing 1410 is preferably of a conductive metal and can be manufactured, for example, through die casting. In non-shielding applications, the housing is of preferably of non-conductive material such as plastic. The three-way coupler 1400 additionally includes a contact sub-assembly 1416 contained within the housing 1410.

The first body portion 1412 includes an upper wall 1420 and a lower wall 1422 connected by side walls 1424 and 1426 to present a first face 1427 that includes first and second connector-receiving channels 1428A, 1428B, which are divided by a central wall 1429, and a second face 1430 that includes an opening 1432 to receive the second body portion 1414. Each of the side walls 1422, 1424 includes an opening 1434, a pair of slots 1436, and a wire tie retainer 1438. The central wall 1429 includes an opening 1440 to either side and proximate the first face that is positioned opposite the opening 1434. Two retention clips 1442, each of which includes an interface tab 1444 and a pair of flex arms 1446, are provided for each of the connector-receiving channels 1428A, 1428B. The interface tab 1444 of each of the retention clips 1442 interfaces with one of the openings 1434 or 1440 to maintain its position within the respective connector-receiving channel 1428A, 1428B. In shielding applications, the interface tab 1444 is preferably of a conductive metal to establish a conductive interface between the first body portion 1412 and the connector 200 received within the respective connector-receiving channel 1428A, 1428B. The wire tie retainer 1438 provides an opening through which a cable tie, or other suitable tie, can be inserted for securing the coupler 1400 in a certain location.

In the instance of an application requiring shielding, a wire coupled to ground can be wound about (or screwed to) the wire tie retainer 1438 thereby tying the connector 200 and the coupler 1400 to ground.

The second body portion 1414 includes a lip edge 1450 defining a forward portion 1452 presenting a connector-receiving channel 1428C and a rearward portion 1454 presenting a sub-assembly housing 1456 for housing the contact sub-assembly 1416. The forward portion 1452 includes an upper wall 1470 and a lower wall 1472 connected by side walls 1474 and 1476 that form the connector-receiving channel 1428C. Each of the side walls 1474, 1476 includes an opening 1478 to interface with the interface tab 1444 of an additional respective retention clip 1442. The sub-assembly housing 1456 of the rearward portion 1454, which is received within the opening 1432 of the first body portion 1412, includes an upper wall 1480 and lower wall 1482 connected by side walls 1484 and 1486. Each of the side walls 1484, 1486 includes a pair of ramped tabs 1488 that interface with the corresponding openings 1436 of the first body portion 1412 to retain the second body portion 1414 in a closed position relative to the first body portion 1412.

The sub-assembly 1416 includes three pairs of contacts 1490 with each pair of contacts including a first contact 1490A and a second contact 1490B as well as three identical contact support blocks 1492 and a circuit board 1494. Each of the contacts 1490 includes a first end 1496 comprising a pin contact that is received within a tuning fork receptacle contact 254a, 254b of the connector 200 and a second end 1498 inserted into a corresponding via 1499 on the circuit board 1494. Each pair of contacts 1490 is supported by a respective slot 1500 of the contact support block 1492 through which the contact 1490 extends. The contact support blocks 1492 are preferably of a lightweight non-conductive material such as plastic. A first set of traces on the circuit board 1494 electrically connect all first contacts 1490A to one another while a second set of traces on the circuit board 1494 electrically connect all second contacts 1490B to one another.

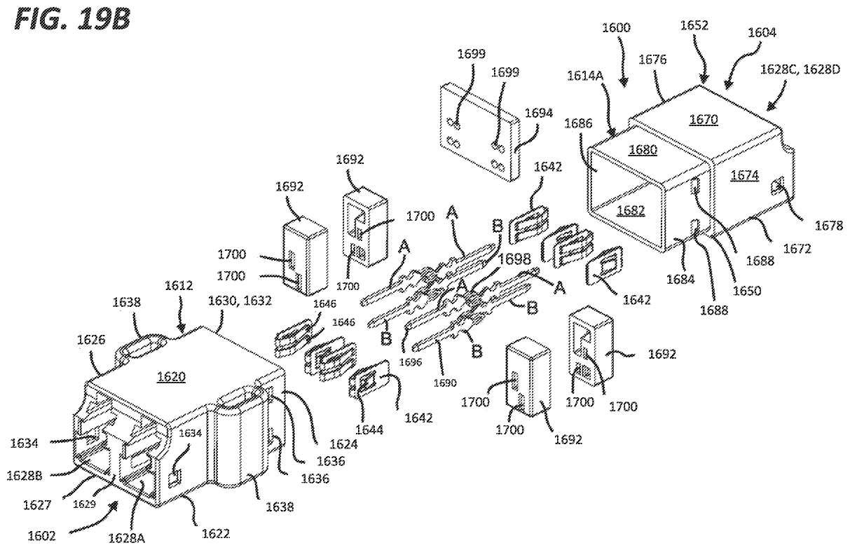

Referring to FIGS. 19A-19B a four-way coupler 1600 includes a housing 1610 comprising a first body portion 1612, which is identical to and interchangeable with the first body portion 1412 of the three-way coupler 1400, that presents a dual-connector end 1402 and a second body portion 1614 presenting the second dual-connector end 1604. For applications requiring shielding, the housing 1610 is preferably of a conductive metal and can be manufactured, for example, through die casting. In non-shielding applications, the housing is of preferably of a non-conductive material such as plastic. The four-way coupler 1600 additionally includes a contact sub-assembly 1616 contained within the housing 1610.

The first body portion 1612 of the four-way coupler includes an upper wall 1620 and a lower wall 1622 connected by side walls 1624 and 1626 to present a first face 1627 that includes first and second connector-receiving channels 1628A, 1628B, which are divided by a central wall 1629, and a second face 1630 that includes an opening 1632 to receive the second body portion 1614. Each of the side walls 1622, 1624 includes an opening 1634, a pair of slots 1636 and a wire tie retainer 1638. The central wall 1629 includes an opening 1640 to either side and proximate the first face that is positioned opposite the opening 1634. Two retention clips 1642, each of which includes an interface tab 1644 and a pair of flex arms 1646, are provided for each of the connector-receiving channels 1628A, 1628B. The interface tab 1644 of each of the retention clips 1642 interfaces with one of the openings 1634 or 1640 to maintain its position within the respective connector-receiving channel 1628A, 1628B. In shielding applications, the interface tab 1644 is preferably of a conductive metal to establish a conductive interface between the first body portion 1612 and the connector 200 received within the respective connector-receiving channel 1628A, 1628B. The wire tie retainer 1638 provides an opening through which a cable tie, or other suitable tie, can be inserted for securing the coupler 1600 in a certain location. In the instance of an application requiring shielding, a wire coupled to ground can be wound about (or screwed to) the wire tie retainer 1638 thereby tying the connector 200 and the coupler 1600 to ground.

The second body portion 1614 includes a lip edge 1650 defining a forward portion 1652 presenting first and second connector-receiving channels 1628C, 1628C and a rearward portion 1654 presenting a sub-assembly housing 1656 for housing the contact sub-assembly 1616. The forward portion 1652 includes an upper wall 1670 and a lower wall 1672 connected by side walls 1674 and 1676 that, along with a central wall 1677, form the connector-receiving channels 1628C and 1628D. Each of the side walls 1674, 1676, as well as each side of the central wall 1677, includes an opening 1678 to interface with the interface tab 1644 of additional respective retention clips 1642. The sub-assembly housing 1656 of the rearward portion 1654, which is received within the opening 1632 of the first body portion 1612, includes an upper wall 1680 and lower wall 1682 connected by side walls 1684 and 1686. Each of the side walls 1684, 1686 includes a pair of ramped tabs 1688 that interface with the corresponding openings 1636 of the first body portion 1612 to retain the second body portion 1614 in a closed position relative to the first body portion 1612.

The sub-assembly 1616 includes four pairs of contacts 1690 with each pair of contacts including a first contact 1690A and a second contact 1690B as well as four identical contact support blocks 1692 and a circuit board 1694. Each of the contacts 1690 includes a first end 1696 comprising a pin contact that is received within a tuning fork receptacle contact 254a, 254b of the connector 200 and a second end 1698 inserted into a corresponding via 1699 on the circuit board 1694. Each pair of contacts 1690 is supported by a respective slot 1700 of the corresponding contact support block 1692 through which the contact 1690 extends. The contact support blocks 1692 are preferably of a lightweight non-conductive material such as plastic. A first set of traces on the circuit board 1694 electrically connects all first contacts 1690A to one another while a second set of traces on the circuit board 1694 electrically connects all second contacts 1690B to one another.

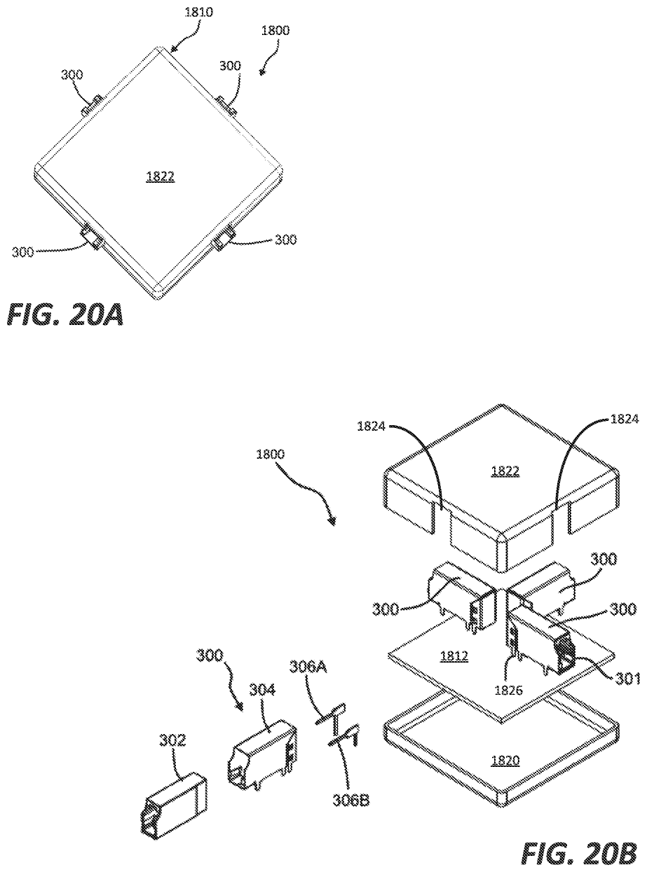

FIGS. 20A-20B illustrate a multi-way coupler 1800 that can be configured to electrically couple two, three, four, or more connectors 300. The multi-way coupler 1800 has a housing 1810 that can be fabricated with conductive metal for shielding applications or non-conductive materials for non-shielding applications. The multi-way coupler generally includes the housing 1810, a circuit board 1812, and two, three, or four connectors 300.

The housing 1810 of the multi-way coupler 1800 includes a base 1820 and a lid 1822, which can interface via a friction fit or other suitable manner of securing the base 1820 to the lid 1822. The lid 1822 includes a plurality of ports 1824 which can be closed off or left open to accommodate a forward face 301 of the connector 300; ports 1824 can be arranged one on each side as illustrated or with multiple ports 1824 on one or more sides. In the embodiment shown, the lid 1822 includes four ports 1824 each of which is open to accommodate the connector 300. The housing 1810 is sized to accommodate the circuit board 1812; the housing 1810 and circuit board 1812 may or may not be of a similar shape. Each of the connectors 300 includes two pin contacts including 306a, 306b each having one end that electrically interfaces (e.g., vias 1826 or soldering) with the circuit board 1812. A first set of traces electrically connect all of the 306a contacts while a second set of traces electrically connect all of the 306b contacts of the connectors 300. In shielding applications, the connectors 300 include the metal frames 304, which are electrically coupled to the circuit board 1812 and are in direct contact with the metal housing 1810 of the multi-way coupler 1800. In non-shielding applications, the connectors 300 need not include their respective metal frames 304. As with the three-way couplers 1400 and the four-way couplers 1600, the multi-way coupler 1800 can utilized in a daisy chain style configuration with one port of the multi-way coupler 1800 dedicated receiving power and/or data from a supply source and one port of the multi-way coupler 1800 dedicated to supply power and/or data to another multi-way coupler 1800; remaining ports on the on the multi-way coupler 1800 can be connected via patch cords to power devices thereby suppling power and/or data.

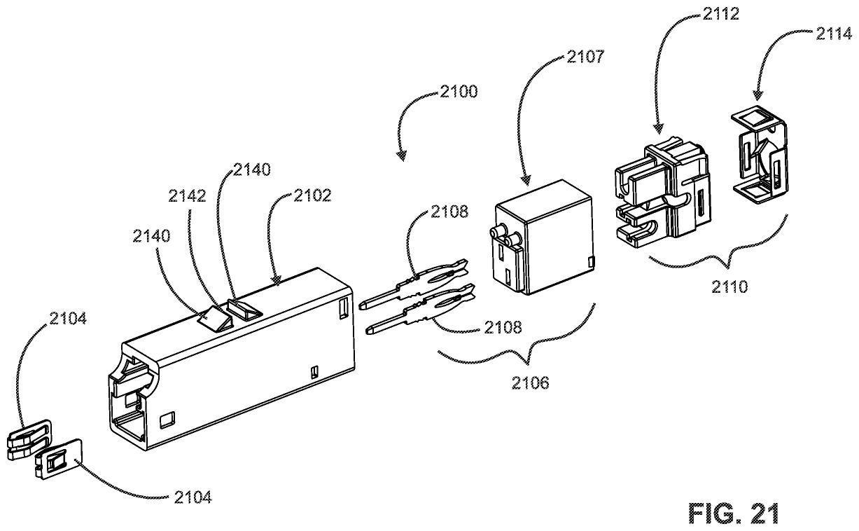

Referring to FIG. 21 a connector jack 2100 according to the present disclosure can be appreciated. The connector jack 2100 includes a singular metal housing 2102, two bonding shield contacts 2104 (which correspond to the bonding shield contacts illustrated in FIGS. 14A-14C), a forward sub-assembly 2106 that includes a forward housing 2107, supporting contacts 2108, and a rear sub-assembly 2110 that includes a rearward housing 2112 and a bonding shield panel 2114. Note the metal housing 2102 is particularly suited to shielded applications; in unshielded applications that housing 2102 can be manufactured from a non-metal material (e.g., plastic, etc.).

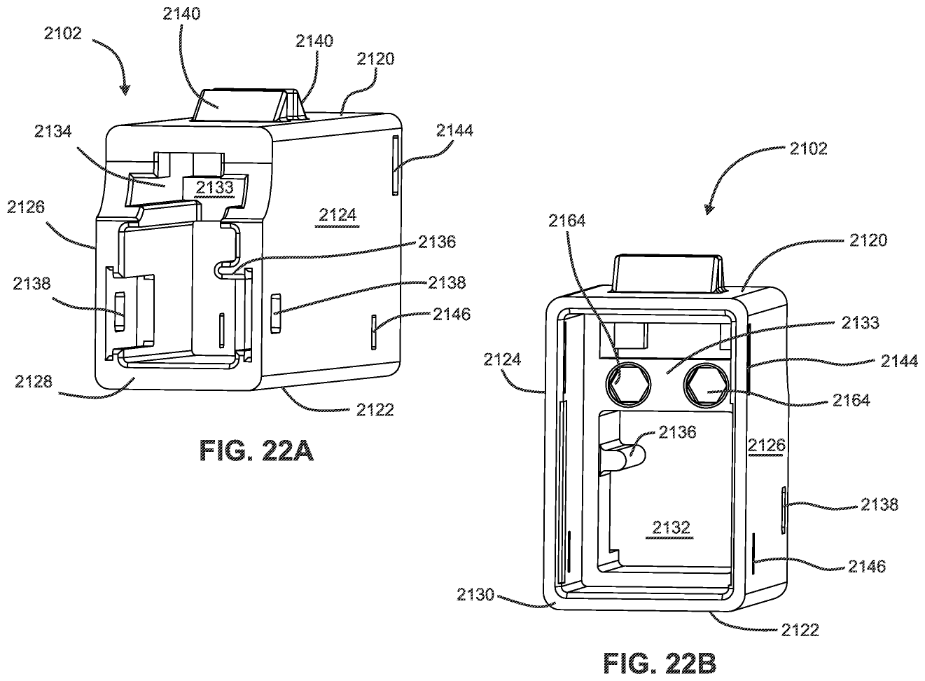

Referring to FIGS. 22A-22B, the housing 2102, which is typically die cast metal, includes an upper face 2120 and a lower face 2122 that are connected by a first side face 2124 and a second side face 2126 defining a forward face 2128 of the housing 2102 and a rearward face 2130 of the housing 2102. A central channel 2132 extends between the forward face 2128 and the rearward face 2130, and within the central channel 2132, a cross bar 2133 extends between the first and second side faces 2124, 2126.

The forward face 2128 is designed to receive a connector 200 and, as such, includes a recessed notch 2134 that is configured to interface with and retain the cantilevered latch 230 of the connector 200. In certain embodiments, a projection 2136 extends from one of the faces 2120, 2122, 2124, 2126 into the central channel 2132. The first and second faces 2124, 2126 each include a recess 2138 proximate the forward face 2128 to receive a respective one of the two bonding shield contacts 2104, which are press fit therein. The upper face 2120 of the housing 2102 includes first and second bosses 2140 that extend outward from the upper face 2120 and oppose one another to define a channel 2142 (see FIG. 21) therebetween. The rearward face 2130 of the housing 2102 presents an unobstructed opening to the central channel 2132. Each of the first and second side faces 2124, 2126, proximate the rearward face 2130, present an upper recess 2144 to interface with and retain the rearward sub-assembly 2110 and a lower recess 2146 to interface with and retain the forward sub-assembly 2106.

Note that the bosses 2140 and channel 2142 provide a latching feature for the connector jack 2100, which enables the connector jack 2100 to be mounted, for example, in a high density panel 1200 illustrated in FIGS. 12A-12B and further allows the connector jack 2100 to be interchangeable with the coupler 400. In certain embodiments, the housing 2102 of the connector jack 2100 has the same outside surface dimensions as the coupler 400. In certain embodiments, the latching feature created by the bosses 2140 and the channel 2142 can be replaced with a different style of latching feature such as an SL-series latching feature, an M-series latching feature, a keystone latching feature, etc.

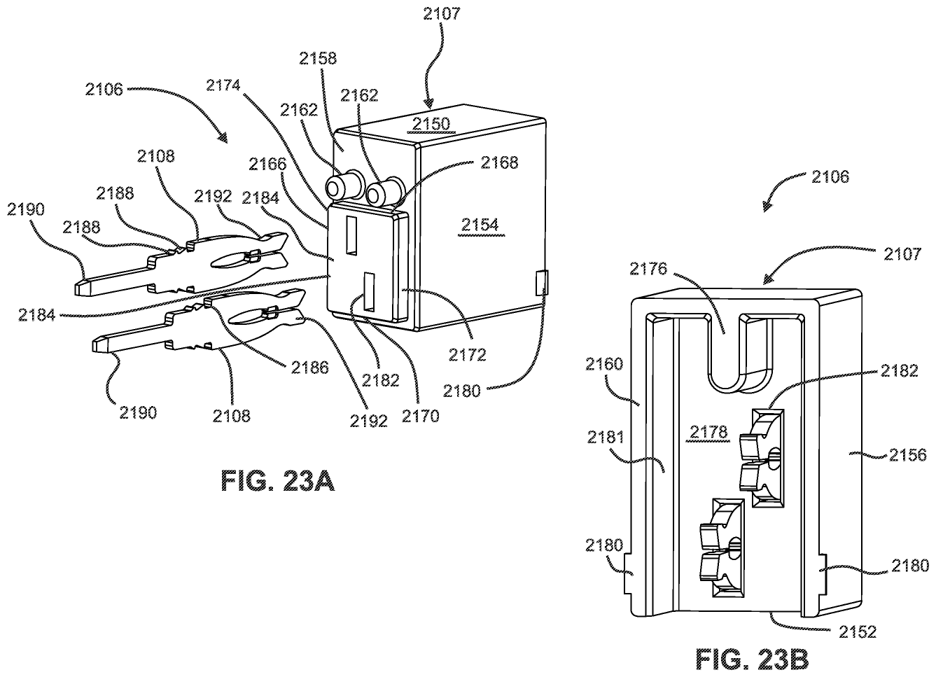

Referring to FIGS. 23A-23B, aspects of the forward sub-assembly 2106 can be appreciated. As shown, the plastic forward housing 2107 of the forward sub-assembly 2106 includes an upper face 2150 and a partial lower face 2152 connected by first and second side faces 2154, 2156. The upper, partial lower, first side, and second side faces 2150, 2152, 2154, 2156 define a forward face 2158 while the upper, first side, and second side faces 2150, 2154, 2156 define a rearward face 2160 of the forward sub-assembly 2106.

The forward face 2158 of the forward housing 2107 includes a pair of projections 2162 that interface with corresponding cavities 2164 (see FIG. 22B) in the cross bar 2133 of the connector jack housing 2102. A locking interference fit occurs between the projections 2162 and cavities 2164 to assist in retaining the position of the forward housing 2107 in the housing 2102 of the connector jack 2100. The forward face 2158 also includes a contact projection 2166 presenting an upper face 2168 and a lower face 2170 connected by first and second side faces 2172 and 2174. When the forward housing 2107 is fully inserted within the housing of the connector jack 2100, the upper face and lower face 2168, 2170 establish an interface fit with the cross bar 2133 and an interior surface of the lower face 2122 of the connector jack housing 2102. Similarly, first and second side faces 2172, 2174 establish an interference fit with the interior of the first and second side faces 2124, 2126 of the connector jack housing 2102.

The rearward face 2160 of the forward housing 2107 presents a keying projection 2176 that extends to a central interior wall 2178 as well as ramped tabs 2180 at first and second side faces 2154, 2156. The keying projection 2176 assists in positioning the rearward sub-assembly 2110 while the ramped tabs 2180 interface with the lower recesses 2146 of the connector jack housing 2102. The ramped tabs 2180 provide additional latching/hold of the forward sub-assembly 2106 in housing 2102 as an optional design feature. In certain embodiments, the ramped tabs 2180 and lower recesses 2146 of the connector jack housing 2102 are eliminated from the design. Note that interior side walls 2181 (proximate the central interior wall 2178), being of a plastic material, help to prevent conductors (e.g., conductors 12, 14) that are interfacing with the contacts 2108 from contacting the metal connector jack housing 2102 and shorting out.

First and second contact slots 2182 extend from the central interior wall 2178 through a forward face 2184 of the contact projections 2166 to receive and support the first and second contacts 2108. A stop feature (not shown) within each slot 2182 interfaces with a stop edge 2186 of each contact 2108 to prevent over-insertion of the contact 2108. Each of the contacts 2108 is also provided with one or more tangs 2188 to help retain each contact 2108 within its respective slot 2182. A forward end 2190 of each contact 2108 presents a pin contact configured similarly to pin contacts 306a, 306b, 408 in order to interface with the electrical contacts 206 of the connector 200 when received at the forward face 2128 of the connector jack housing 2102. A rearward end 2192 of each contact 2108 is configured with an insulation displacement contact (IDC) to interface with, for example, first and second conductors 12, 14 of single pair cable 10. In certain embodiments, both the forward and rearward ends 2190, 2192 of the contacts 2108 are IDCs and the connector jack housing 2102 is configured with a rear sub-assembly at each end as opposed to a one rear sub-assembly end and one connector receiving end. Further in certain embodiments, the connector receiving end is provided in a fixed connector configuration.

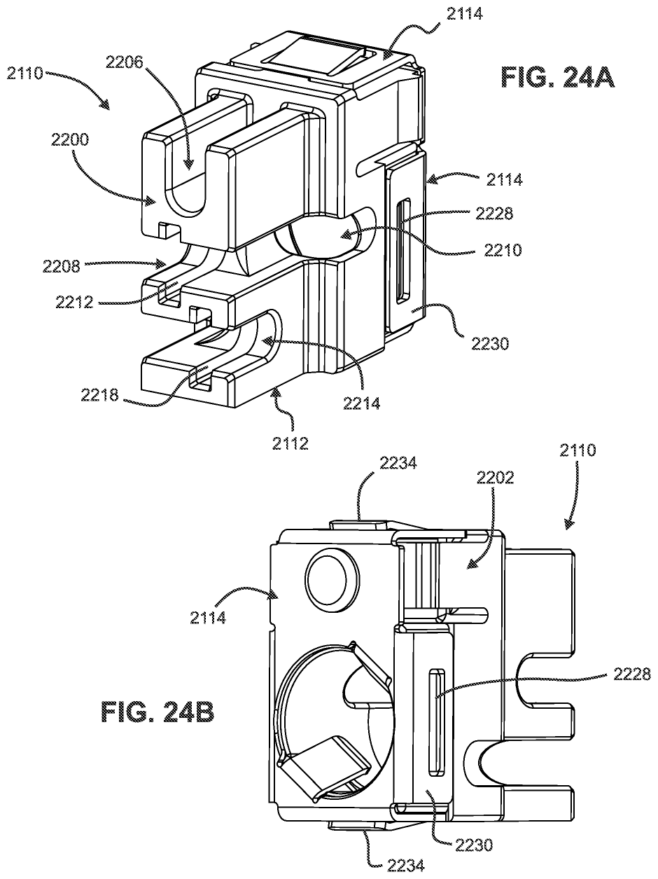

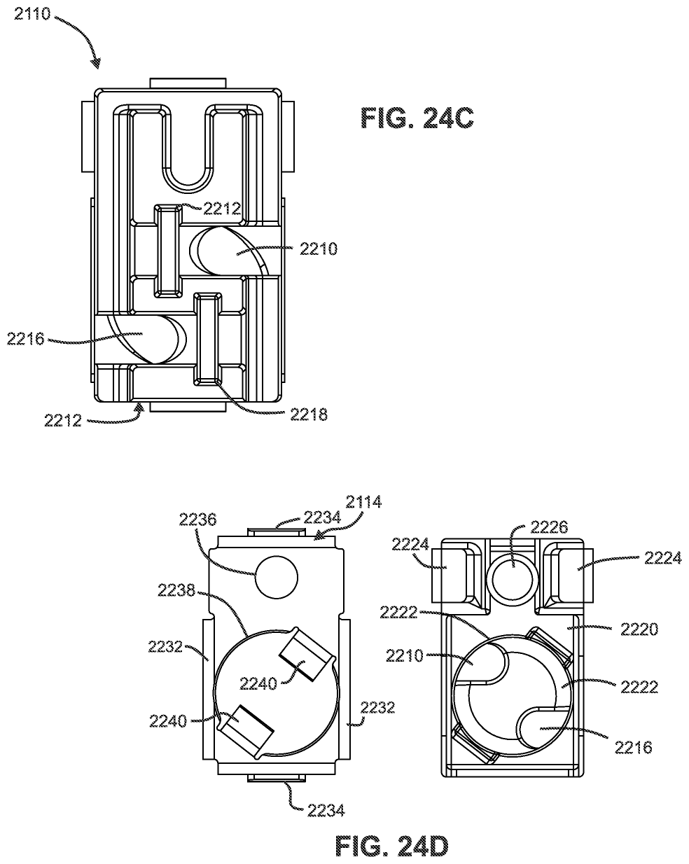

Referring to FIGS. 24A-24B, aspects of the rear sub-assembly 2110 of the connector jack 2100 can be appreciated. As shown the plastic rearward housing 2112 includes a forward lacing portion 2200 unitary with a rearward cable receiving portion 2202.

The forward lacing portion 2200 includes an upper central recess 2206 to accommodate the keying projection of the 2176 of the forward sub-assembly 2106. The forward lacing portion 2200 additionally includes an upper cross-channel 2208 in which an insulated conductor (e.g., conductor 12), received through a first conductor opening 2210, can be placed. A first IDC slot 2212 positioned perpendicular to the upper cross-channel 2208 receives the rearward IDC end 2192 of the contact 2108 whereby the IDC cuts the insulation about the conductor to establish electrical contact with the conductor. The forward lacing portion 2200 also includes a lower cross-channel 2214 in which an insulated conductor (e.g., conductor 14), received through a second conductor opening 2216, can be placed. A second IDC slot 2218 positioned perpendicular to the lower cross-channel 2214 receives the rearward IDC end 2192 of the other of the contacts 2108 to similarly establish electrical contact with the conductor. In certain embodiments, the upper and lower cross-channels 2208, 2214 may include conductor retaining features to maintain the position of the conductors in the cross-channels 2208, 2214. The configuration of the forward lacing portion 2200 along with the IDCs enables tool-less conductor termination. In certain embodiments, the forward lacing portion 2200 includes polarity indicia (e.g., “+”, “−”).

The rearward cable receiving portion 2202 of the rearward housing 2112 presents a rear face 2220 having a cable opening 2222 presenting a channel to conductor openings 2210, 2216. The rearward cable receiving portion 2202 of the rearward housing 2112 additionally includes ramped tabs 2224 to either side to interface with upper recesses 2144 of the connector jack housing 2102 to retain the rearward sub-assembly 2110 within the connector jack housing 2102. Note that the tip of a screwdriver can be used to release the ramped tabs 2224 from the recesses 2144 if needed to remove the forward sub-assembly 2106 from the connector jack housing 2102. A projection 2226 is provided on the rear face 2220 to support the bonding shield panel 2114. A hot or cold thermoplastic staking process can be performed on the projection 2226 causing it to expand and flatten outward to permanently retain the bonding shield panel 2114 proximate the rearward housing 2112. Further, tabs 2228 are provided to either side of the rearward cable receiving portion 2202 to interface with corresponding slots 2230 on the metal bonding shield panel 2114 helping to retain the metal bonding shield panel 2114 in a desired position.

The metal bonding shield panel 2114, typically manufactured with sheet metal, presents first and second side flaps 2232 that contain the slots 2230 as well as upper and lower flex tabs 2234; side flaps 2232 and flex tabs 2234 establish metal-to-metal shielding contact with the connector jack housing 2102 when the rearward sub-assembly 2110 is fully inserted within the connector jack housing 2102. The bonding shield panel 2114 additionally includes an opening 2236 to receive the projection 2226 of the rearward cable receiving portion 2202 of the rearward housing 2112 and a cable opening 2238 corresponding to the cable opening 2222 of the rearward housing 2112. Flex shielding beams 2240 extend from cable opening 2238 into the channel that extends towards the conductor openings 2210, 2216. The flex shielding beams 2240 establish a bonding path between a single pair cable (e.g., cable 10) inserted in the rear sub-assembly 2110 by being in contact with shield features of the cable such as foil, drain wire and/or braid. The bonding path then continues from the metal bonding shield panel 2114 to the metal connector jack housing 2102 where the bonding path can then continue to a patch panel. The flex shielding beams 2240 also serve a second purpose of providing cable jacket strain relief. Note that a bonding path is also established at the forward face 2128 of the connector jack housing upon insertion of a connector 200 with the metal shielding of the connector 200 being placed in contact with bonding shield contacts 2104 which are in contact with the metal connector jack housing 2102.

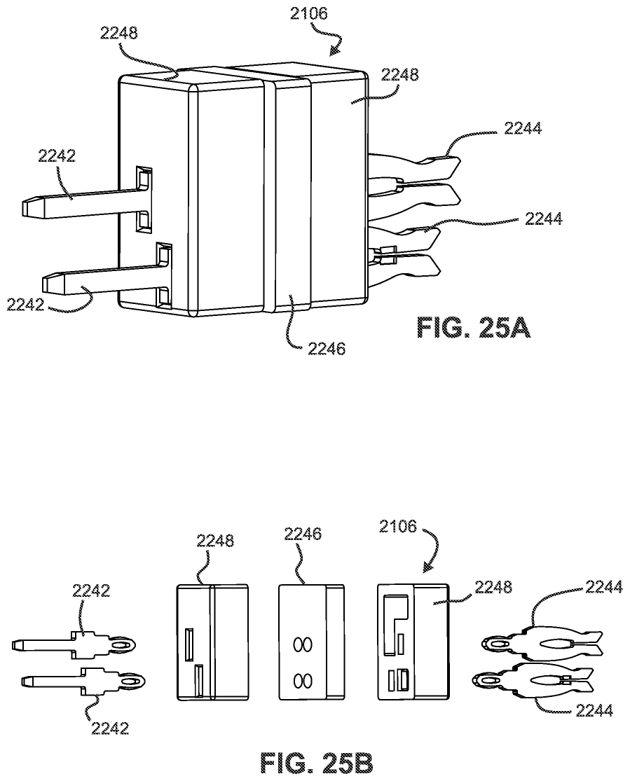

Referring to FIGS. 25A-25B, an alternative embodiment of the forward sub-assembly 2106 for the connector jack 2100 is illustrated. In the illustrated embodiment, contacts 2108 are replaced with two forward contacts 2242 and two rearward contacts 2244. The forward and rearward contacts 2242, 2244 are electrically coupled through use of traces and/or vias of a printed circuit board (PCB) 2246. Contact support blocks 2248 are provided to either side of the PCB 2246. While not shown, the contact support blocks 2248 are provided with the various interfacing features that enable the forward sub-assembly to interface with the connector jack housing 2102 and the rear sub-assembly 2110.

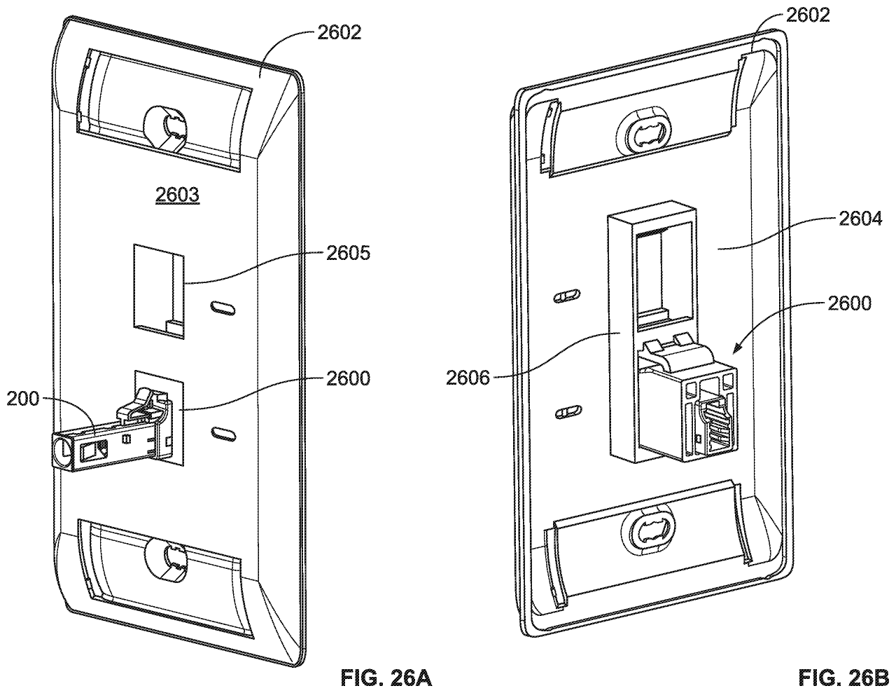

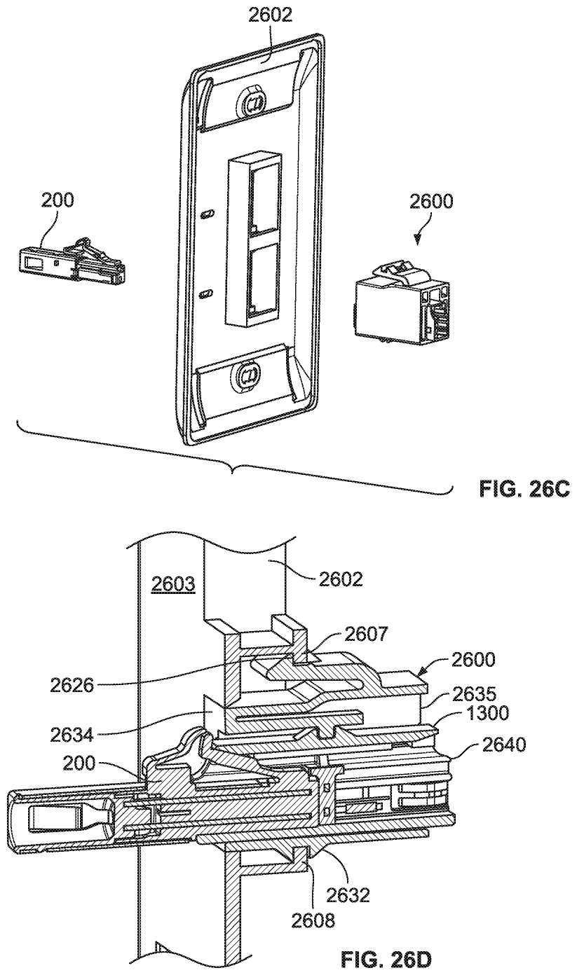

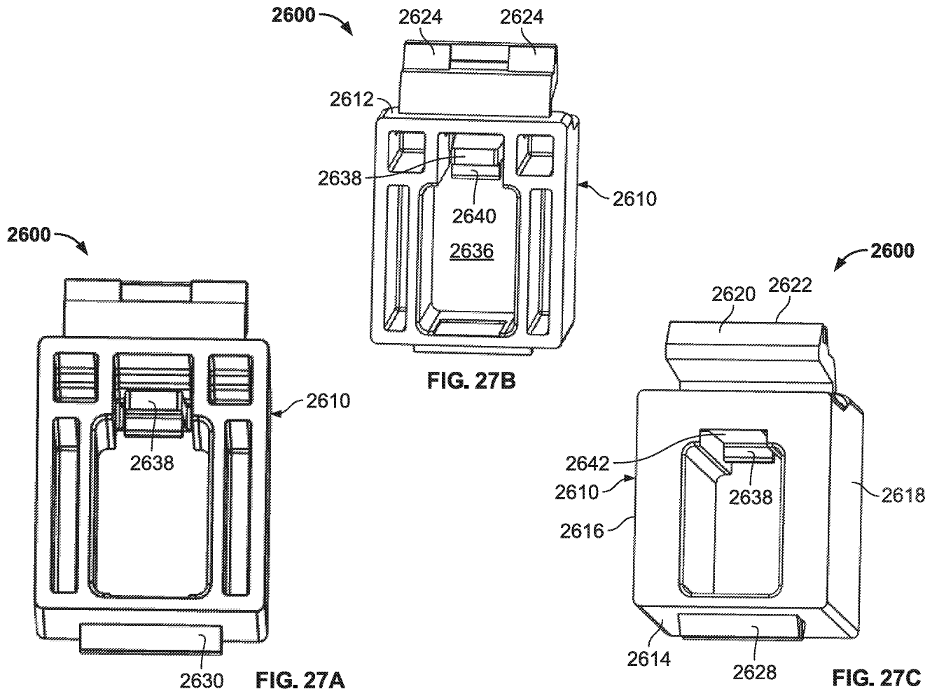

Referring to FIGS. 26A-26D and 27A-27C, a mount housing 2600 that can be used to support a connector jack, such as connector jack 2100, or an inline coupler, such as coupler 400 or coupler 1300, within a faceplate 2602 is illustrated. In the example shown, an inline coupler 1300 is shown positioned within the mount housing 2600 and a free connector 200 is shown interfacing with a first end of the coupler 1300; a second free connector 200 (or a single pair Ethernet cable in the instance of the connector jack 2100) is suited to interface with a second end of the coupler 1300. In the illustrated example, the mount housing 2600 is of an SL Series interface configured to interface with an SL Series faceplate 2602 which includes a forward face 2603, a rearward face 2604, and one or more mount openings 2605; each of the mount openings 2605 is bounded by a framework 2606 presenting an upper edge 2607 and lower edge 2608 at each mount opening 2605 for interfacing with the mount housing 2600. Note that the SL Series interface is proprietary to Commscope, Inc.

The mount housing 2600 is generally fabricated from a plastic or plastic-type material that can be color-coded. A body 2610 of the mount housing 2600 includes an upper face 2612 and a lower face 2614 connected by first and second side faces 2616, 2618. An exterior interface feature comprising a flexible latch 2620 extends upward from the upper face 2612 of the body 2610. The flexible latch 2620 includes a forward and rearward lip edge 2622, 2624 that define a channel 2626 to interface with the upper edge 2607 of the framework 2606 of the faceplate 2602. Further, additional interface features comprising first and second ramped bosses 2628, 2630 extend from the lower face 2614 of the body 2610 to define a channel 2632 that interfaces with the lower edge 2608 of the framework 2606 of the faceplate 2602.

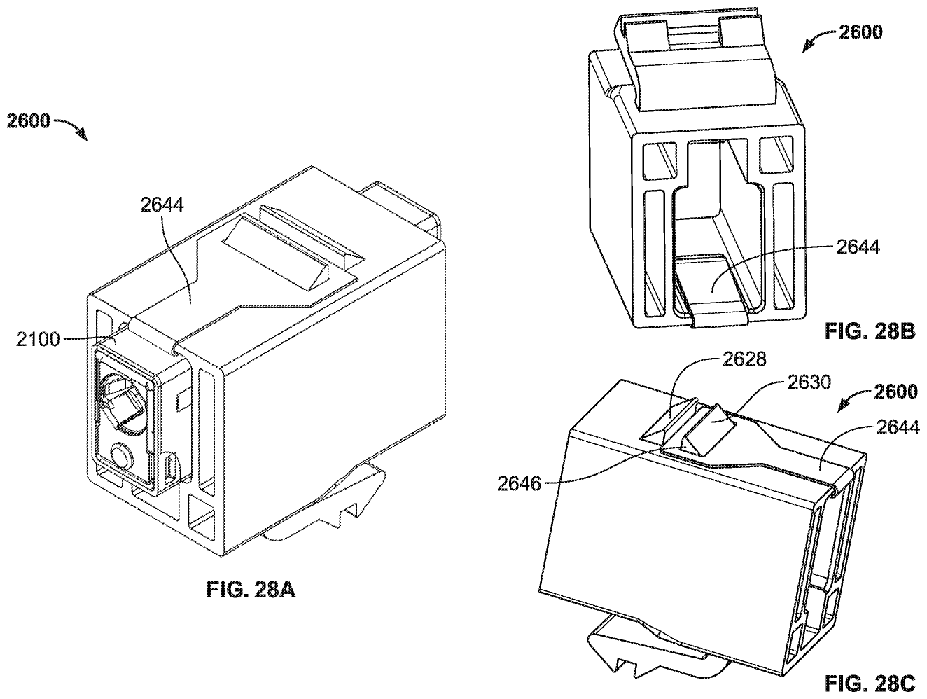

With each of the channels 2626, 2632 interfacing with the framework 2606 of the faceplate 2602, a forward face 2634 of the mount housing 2600 is positioned flush with the forward face 2603 of the faceplate 2602. Note that a forward face of a coupler (e.g., 400, 1300) or connector jack (e.g., 2100) positioned within the mount housing 2600 extends beyond the forward face 2603 of the faceplate 2602 and beyond both the forward face 2634 and a rearward face 2635 of the mount housing 2600. A central channel 2636, which receives the coupler or connector jack, is defined within the upper, lower, first, and second side faces 2612, 2614, 2616, 2618 of the body 2610 of the mount housing 2600. An interior interface feature comprising an interior flex latch 2638 extends from an inner surface of the upper face 2612 into the central channel 2636 and includes a protrusion 2640 to interface with opposing bosses 730 of coupler 400, opposing bosses 1327 of coupler 1300, or with first and second bosses 2410, 2412 of a connector jack. In certain embodiments, for example, if the mount housing 2600 is used in an application where shielding is required, a recess 2642 is provided on an interior surface of the lower face 2614 of the body 2610 to accommodate a metal spring beam 2644 (see FIGS. 28A-28C) and the compression of the metal spring beam 2644 when a shielded connector jack or a shielded coupler is inserted therein.

FIGS. 28A-28C illustrate the mount housing 2600 with a metal spring beam 2644 secured to the body 2610 of the mount housing 2600. Note that FIG. 28A illustrates the mount housing 2600 with a connector jack 2100 inserted therein, whereby the metal spring beam 2644 exerts a normal force to interface with the metal housing 2102 to establish a bonding path between the connector jack 2100 (or coupler 400, 1300) and the mount housing 2600. In the illustrated embodiment, the metal spring beam includes a slot 2646 to interface with one of bosses 2628, 2630 of the mount housing 2600.

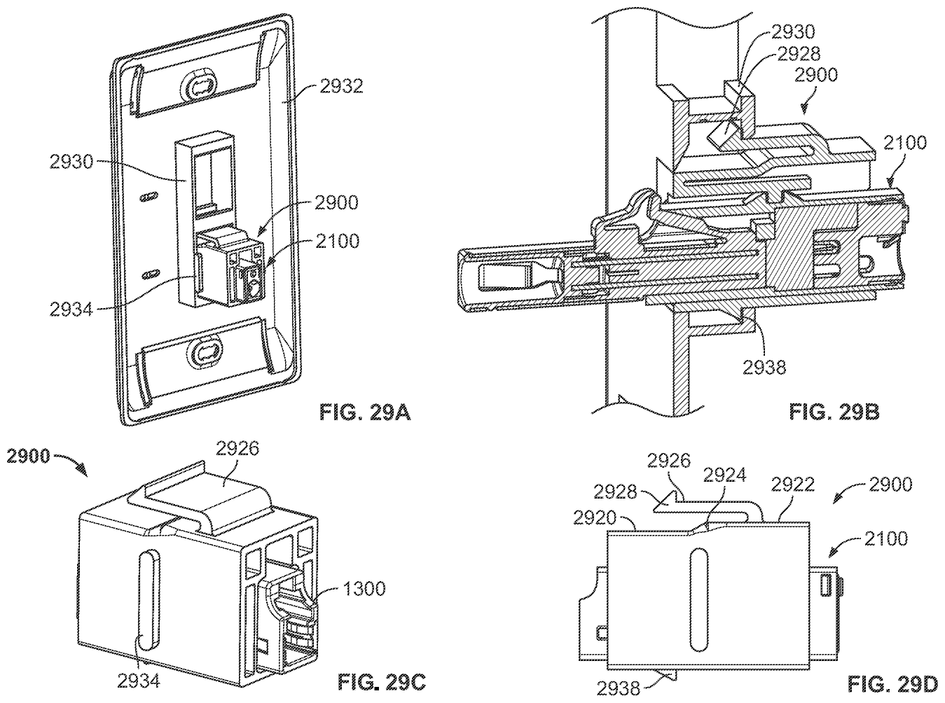

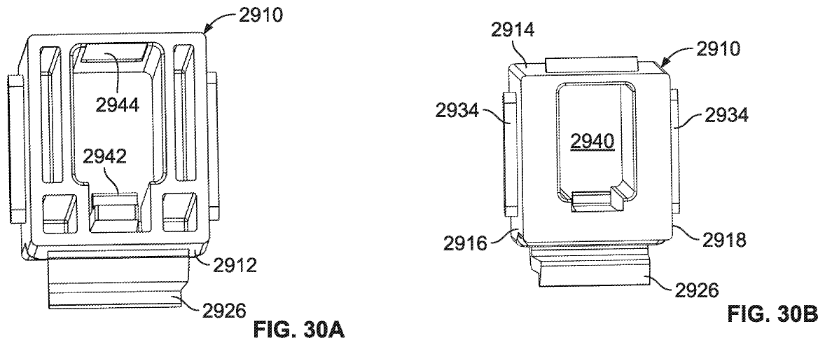

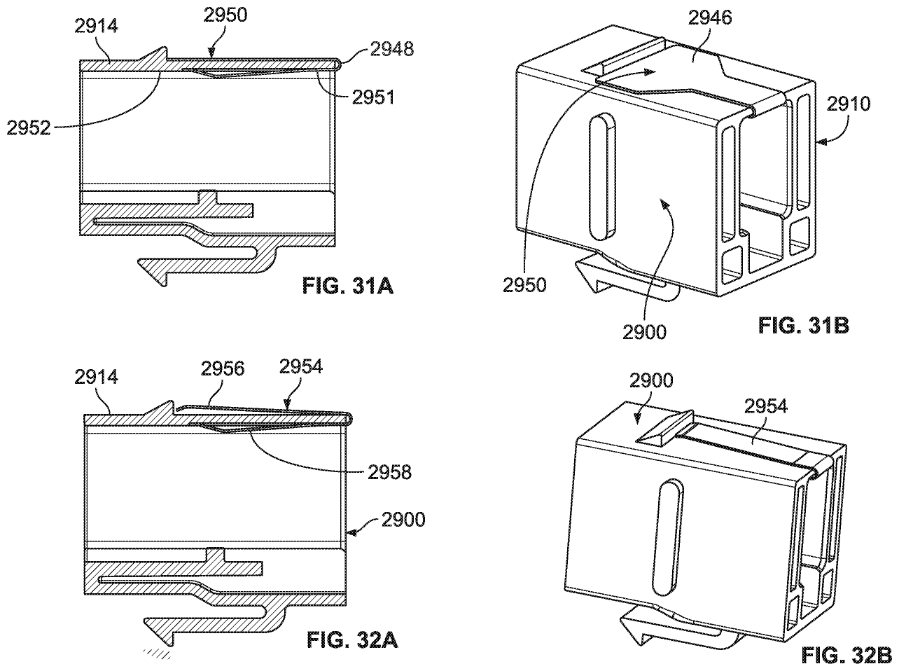

Referring to FIGS. 29A-29D and FIGS. 30A-30B, a mount housing 2900 is illustrated. The mount housing 2900 is a latching mount housing having a Keystone interface configuration meeting the requirements set forth in the International Electrotechnical Commission (IFC) standard IEC 60603-7, Type A, Variant 3. The mount housing 2900 has a body 2910 including an upper face 2912 and a lower face 2914 connected by first and second side faces 2916, 2918. The upper face 2912 includes a forward first portion 2920 that transitions to a rearward second portion 2922 via a ramped portion 2924. An interface feature comprising a flexible latch 2926 extends upward from the rearward second portion 2922 of the upper face 2912 of the body 2910 presenting a lip edge 2928 for interfacing with framework 2930 of a faceplate 2932. Other interface features comprising side projections 2934 are provided on each of the first and second side faces 2916, 2918 and interface with the framework 2930 of the faceplate 2932 when the mount housing 2900 is fully inserted within a mount opening 2936 of the faceplate 2932. An interface feature comprising a ramped protrusion 2938 extends from the lower face 2914 of the body 2910 of the mount housing 2900; the ramped protrusion 2938 also interfaces with the framework 2930 of the faceplate 2932. An interior of the mount housing 2900 is configured similarly to the mount housing 2600 having a corresponding central channel 2940, a corresponding interior flex latch 2942, and an interior recess 2944 to accommodate a metal spring beam 2946 (see FIGS. 31A-31B and FIGS. 32A-32B) and the compression of the metal spring beam 2946 when a shielded connector jack or a shielded coupler is inserted therein; the metal spring beam 2946 is not needed in unshielded applications.

FIGS. 31A-31B illustrate the mount housing 2900 with the metal spring beam 2946 in position relative to the body 2910 of the mount housing 2900. In the illustrated configuration, a top portion 2948 of the metal spring beam 2946 provides a broad portion 2950 approximately spanning a width of the body 2910. Note that in the illustrated configuration, the metal spring beam 2946 does not include an interface slot as provided in the shielded configuration of the mount housing 2600, rather the metal spring beam 2946 merely lies atop the body 2910 (or, alternatively, is bent to provide a normal force against a mating surface) of the mount housing 2900 and wraps a lower portion 2951 toward an interior surface 2952 of the lower face 2914 in position to provide a normal force against a shielded coupler or connector jack.

FIGS. 32A-32B illustrate an alternative embodiment to the metal spring beam 2946. In the illustrated embodiment, a metal spring beam 2954 includes a top portion 2956 that, rather than being flat like top portion 2948, is bent to provide a normal force to mate with a metal mount opening edge (e.g., framework of a faceplate). A lower portion 2958 of the metal spring beam 2954 wraps to an underside interior surface of the lower face 2914 of the body 2910 in position to provide a normal force against a shielded coupler or connector jack.

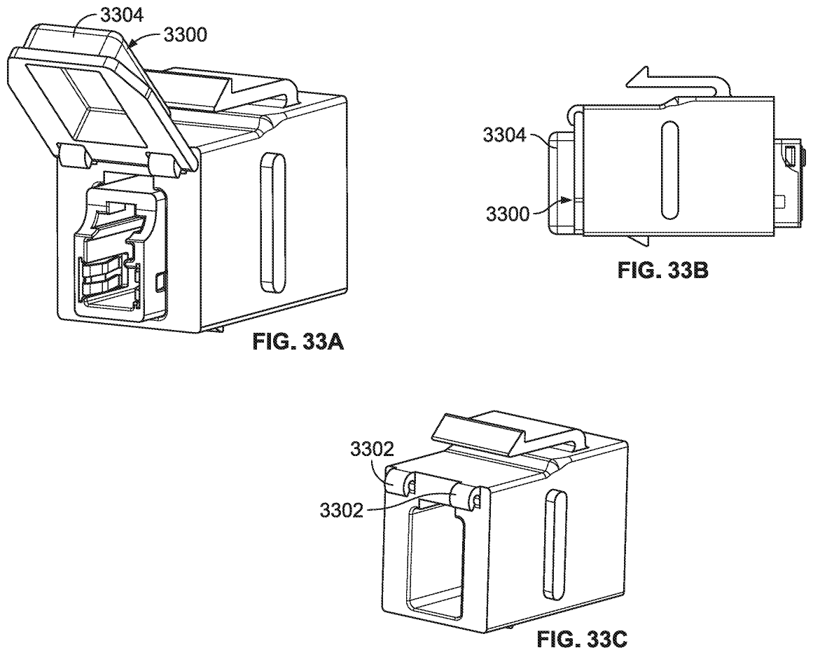

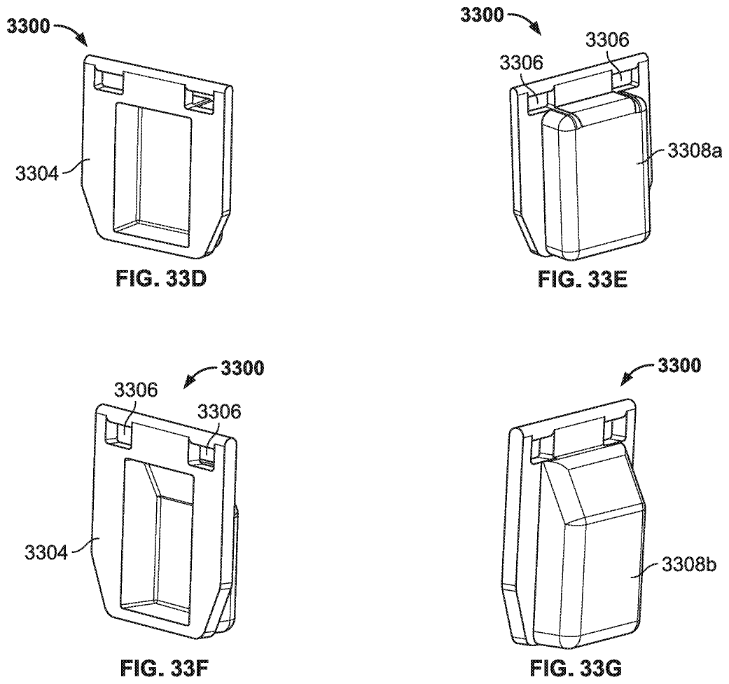

Referring to FIGS. 33A-33G, different example embodiments of an optional dust cover 3300 that can be used with the various mount housings are illustrated. As shown, when a dust cover 3300 is employed, the body of the mount housing is equipped with one or more rounded hinge mounts 3302 to which can be secured a dust cover door 3304 that includes slots 3306 to interface with the hinge mounts 3302. Once the dust cover door 3304 is mounted to the hinge mounts 3302, a friction interference fit is established between the dust cover door 3304 and hinge mounts 3302 enabling the dust cover door to remain in a closed position or an open position as needed. A pop-out portion 3308, having a squared off configuration 3308a or a ramped configuration 3308b, of the dust cover door 3304 accommodates the portion of a coupler or connector jack within the mount housing that extends beyond the forward face of the mount housing, enabling the dust cover 3304 to close against the forward face of the mount housing.

Note that in shielded networks, the dust cover 3300 can provide EMI shielding on the front of the connector jack or coupler within the mount housing when no mating connector is in use. In providing the EMI shielding, the dust cover 3300 is preferably of a thermoplastic composite material that has conductive fibers or powder (e.g., very fine particles) in a polymer matrix. Theses conductive fibers or powder form a mesh that provides the EMI shielding performance. In unshielded networks, no EMI shielding performance is required and the dust cover 3300 can be manufacture from only the thermoplastic composite material.

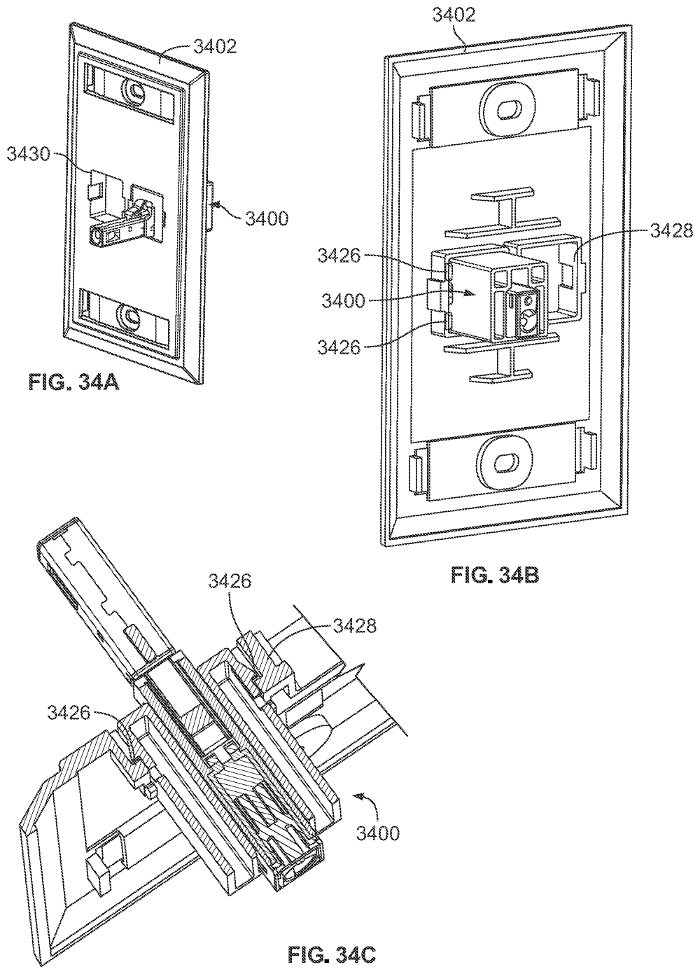

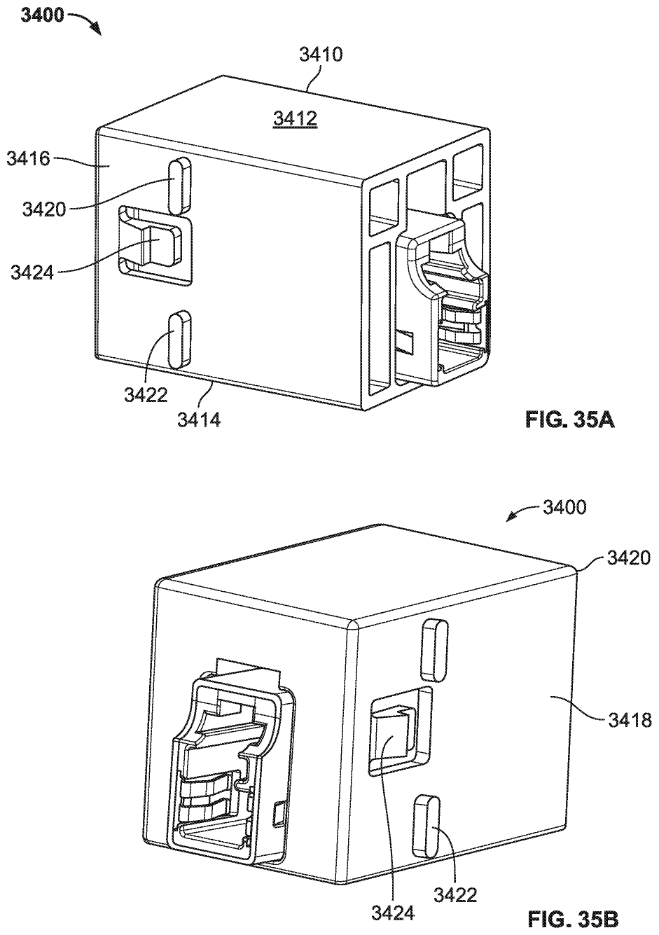

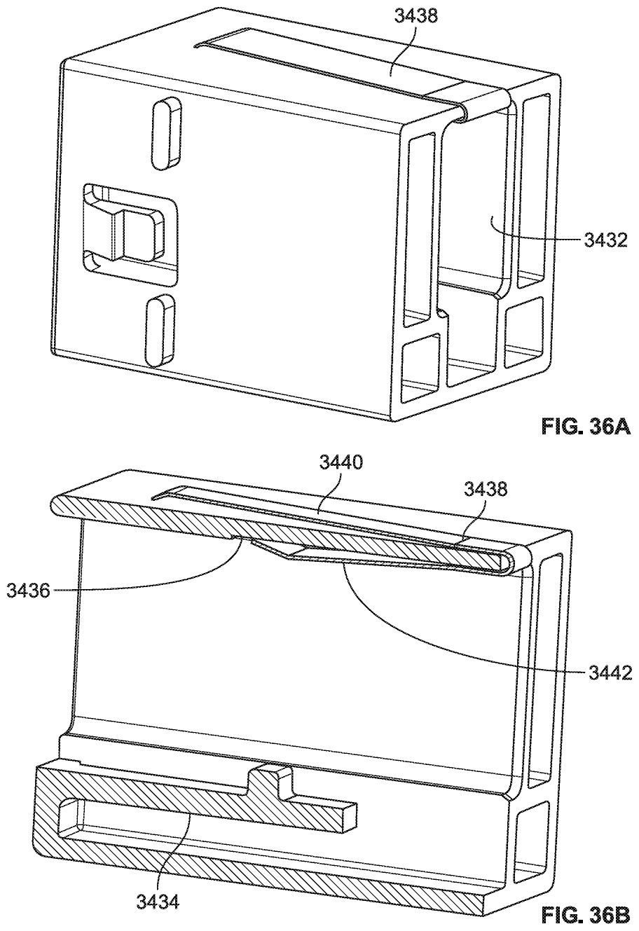

Referring no to FIGS. 34A-34C, FIGS. 35A-35B, and FIGS. 36A-36B, another embodiment of a mount housing 3400 is illustrated. Mount housing 3400 comprises a latching mount housing having an M Series interface configuration for interfacing with an M Series face plate 3402. The M Series interface configuration is proprietary to CommScope, Inc. The mount housing 3400 includes a body 3410 having an upper face 3412 and lower face 3414 connected by first and second side faces 3416, 3418. No latches and/or projections are provided on the upper and lower faces 3412, 3414. Rather, the mount housing 3400 includes interface features comprising upper and lower side projections 3420, 3422 on each of the first and second side faces 3416, 3418 along with a latching flex tab 3424 on each of the first and second side faces 3416, 3418. The side projections 3420, 3422 and flex tab 3424 latch/interface with stops 3426 incorporated into a framework 3428 about one or more mount openings 3430 of the faceplate 3402. An interior of the mount housing 3400 is configured similarly to the mount housing 2600 having a corresponding central channel 3432, a corresponding interior flex latch 3434, and an interior recess 3436 to accommodate a metal spring beam 3438 (if needed, for a shielded application). The metal spring beam 3438 includes upper and lower spring portions 3440, 3442 similar to metal spring beam 2954, with each of the upper and lower spring portions 3440,3442 configured to exert a normal force at a metal interface to maintain a bonding path.

The illustrated removable and reusable mount housings are suitable for use with jack faceplates, as illustrated, or with jack faceplate modules, surface mount jack boxes, and jack mounting straps (e.g., Duplex, Decorator). The mount housings are also suited for panel modules. For example, the mount housings can be used in unshielded and shielded (when using the metal spring feature) patch panels with SL-series, M-series, or Keystone mount openings.

It should be noted the mount housings provide installation and removal of the connector jack or coupler from either the front or rear of the mount housing; installation and removal of the connector jack or coupler from either the front or rear of the mount housing can also occur while the mount housing is mounted into a mount opening.

It will be appreciated that aspects of the above embodiments may be combined in any way to provide numerous additional embodiments. These embodiments will not be described individually for the sake of brevity.

While the present invention has been described above primarily with reference to the accompanying drawings, it will be appreciated that the invention is not limited to the illustrated embodiments; rather, these embodiments are intended to disclose the invention to those skilled in this art. Note that features of one or more embodiments can be incorporated in other embodiments without departing from the spirit of the invention. In the drawings, like numbers refer to like elements throughout. Thicknesses and dimensions of some components may be exaggerated for clarity.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

Herein, the terms “attached”, “connected”, “interconnected”, “contacting”, “mounted” and the like can mean either direct or indirect attachment or contact between elements, unless stated otherwise.

Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A mount housing comprising:
a body having an exterior surface and an open-ended channel extending therethrough, the exterior surface having an exterior interface feature that interfaces with a mount opening framework to retain the body within a mount opening and the channel including an interior interface feature to retain a single pair Ethernet coupler or a single pair Ethernet connector jack therewithin.

2. The mount housing of claim 1, wherein the mount housing further comprises a metal spring beam.

3. The mount housing of claim 2, wherein the metal spring beam interfaces with the exterior interface feature.

4. The mount housing of claim 2, wherein a first portion of the metal spring beam is positioned at a recess in the channel and a second portion of the metal spring beam is positioned atop a top face of the exterior surface.

5. The mount housing of claim 4, wherein at least one of the first portion and the second portion of the metal spring beam exerts a normal force against an opposing surface.

6. The mount housing of claim 1, further comprising a dust cover to cover at least one end of the open-ended channel.

7. The mount housing of claim 1, wherein the interior interface feature comprises a flex latch extending into the channel from an upper surface of the channel.

8. The mount housing of claim 1, wherein the exterior interface feature comprises one or more of a flexible latch, a ramped boss, a projection, and a flex tab.

9. The mount housing of claim 1, wherein the mount opening comprises at least one of a SL-series, a M-Series, or a Keystone mount opening of a faceplate or a panel module.

10. A method of mounting a single Pair Ethernet coupler or connector jack in a mount opening, the method comprising:
inserting the single pair Ethernet coupler or connector jack into a mount housing, the mount housing including an interior interface feature to removably retain the single pair Ethernet coupler or connector jack within a channel of the mount housing; and
inserting the mount housing into a mount opening having a framework about the mount opening, the mount housing including an exterior interface feature that interfaces with the framework to removably retain the mount housing within the mount opening.

11. The method of claim 10, wherein a forward face of the mount housing is flush with a forward surface defining the mount opening upon insertion of the mount housing in the mount opening.

12. The method of claim 11, wherein a forward face of the single pair Ethernet coupler or connector jack extends beyond a forward face of the mount housing upon insertion of the coupler or connector jack in the channel of the mount housing.

13. The method of claim 10, wherein the interior interface feature comprises a flex latch extending into the channel of the mount housing from an upper surface of the channel.

14. The method of claim 10, wherein the exterior interface feature comprises one or more of a flexible latch, a ramped boss, a projection, and a flex tab.

15. The method of claim 10, wherein the exterior interface feature provides at least one of an SL-Series interface configuration, a Keystone interface configuration, and an M-Series interface configuration.

16. The method of claim 10, wherein the mount housing includes a plastic body and wherein the method further comprises equipping the plastic body with a metal spring beam, the metal spring beam interfacing with the single pair Ethernet coupler or connector jack, which is in a shielded configuration, and interfacing with the framework of the faceplate, which is in a shielded configuration, to establish a bonding path between the coupler or connector jack and the faceplate upon insertion of the coupler or connector jack into the mount housing and upon insertion of the mount housing in the opening of the faceplate.

17. The method of claim 10, further comprising attaching a dust shield to a forward face of the mount housing.

18. A single pair Ethernet communication system comprising:
a coupler that couples a first single pair Ethernet free connector with a second single pair Ethernet free connector or a connector jack that couples a single pair Ethernet free connector to a single pair Ethernet cable;
a mount housing, the mount housing including an exterior surface and an open-ended channel that receives and removably retains the coupler or connector jack therein; and
a mount opening of a faceplate or panel module, a framework positioned about the mount opening, the mount opening receiving the mount housing and the framework interfacing with an exterior interface feature of the mount housing to retain the mount housing within the mount opening of the faceplate or panel module.

19. The single pair Ethernet communication system of claim 18, wherein the coupler or connector jack are in a shielded configuration and wherein the faceplate or panel module is in a shielded configuration and wherein the mount housing includes a metal spring beam to establish a bonding path between the coupler or connector jack and the faceplate or panel module.

20. The single pair Ethernet communication system of claim 18, wherein the interface between the mount housing and the faceplate or panel module comprises at least one of an SL Series interface configuration, a Keystone interface configuration, and an M Series interface configuration.

21. A telecommunications adapter mount comprising:
a) a main body defining an internal cavity for receiving a telecommunications connector;
b) a first connection arrangement located on an exterior portion of the main body and being configured to removably secure the main body within an opening, the first connection feature being one or more of a flexible latch, a ramped boss, a projection, and a flex tab; and
c) a second connection arrangement located within the internal cavity and being configured to removably secure the telecommunications connector within the channel.

22. The telecommunications adapter mount of claim 21, further including the telecommunications connector, wherein the telecommunications connector is a single pair Ethernet coupler or connector jack.

23. The telecommunications adapter mount of claim 22, wherein a forward face of the single pair Ethernet coupler or connector jack extends beyond a forward face of the main body.

24. The telecommunications adapter mount of claim 21, wherein the second connection arrangement comprises a flex latch extending into the channel from an upper surface of the channel.

25. The telecommunications adapter mount of claim 21, wherein the first connection arrangement provides at least one of an SL-Series interface configuration, a Keystone interface configuration, and an M-Series interface configuration.

26. The telecommunications adapter mount of claim 21, wherein the main body is formed from a plastic material.

27. The telecommunications adapter mount of claim 21, further including a metal spring beam, the metal spring beam configured to interface with the telecommunications connector, which is in a shielded configuration, and to interface with a framework defining the opening, which is in a shielded configuration, to establish a bonding path between the telecommunications connector and the framework upon insertion of the telecommunications connector into the channel and upon insertion of the main body in the opening.

28. The telecommunications adapter mount of claim 21, further comprising a dust shield mounted to a forward face of the main body.
